(19) United States
(12) Patent Application Publication
(10) Pub. No.: US 2020/0001159 A1
(43) Pub. Date: Jan. 2, 2020

(54) INFORMATION PROCESSING APPARATUS, INFORMATION PROCESSING METHOD, AND PROGRAM

(71) Applicant: SONY CORPORATION, Tokyo (JP)

(72) Inventors: Naoya SAZUKA, Tokyo (JP); Yoshihiro WAKITA, Tokyo (JP); Kazuyuki KANOSUE, Tokyo (JP)

(73) Assignee: SONY CORPORATION, Tokyo (JP)

(21) Appl. No.: 16/488,428

(22) PCT Filed: Jan. 5, 2018
(86) PCT No.: PCT/JP2018/000102

§ 371 Date: Aug. 23, 2019

(30) Foreign Application Priority Data
Mar. 28, 2017 (JP) 2017-062660

(51) Int. Cl. A63B 69/00; A63B 71/06; G06N 3/08

(52) U.S. Cl. CPC A63B 69/0035; A63B 71/0622; G06N 3/08; A63B 2071/0666; A63B 2220/836; A63B 2071/0655; A63B 2071/0677; A63B 2220/40

(57) ABSTRACT

There is provided a novel and improved information processing apparatus capable of feeding back a running and walking state to a user in real time and being easily used. The information processing apparatus includes a sensing information acquisition unit that acquires sensing information from a single or a plurality of sensors worn on a body of a user who is running or walking, an estimation unit that estimates a grounding state of a foot of the user from the sensing information, and a notification unit that notifies information regarding a running and walking state of the user on the basis of the estimated grounding state.

### TECHNICAL FIELD

The present disclosure relates to an information processing apparatus, an information processing method, and a program.

### BACKGROUND ART

In recent years, the number of people who play sports on a daily basis has been increased so as to maintain health, develop physical strength, diet, and refresh. In particular, since running can be more easily performed than the other sports, the number of people who enjoy running is remarkably increased. However, it is difficult for a large number of people who enjoy running to obtain an opportunity to receive an instruction regarding a “running style” from a specialist, and those people enjoy running in their own “running style”.

Furthermore, a system has been proposed which feeds back sensing information to the runner and provides an advice to the runner on the basis of the sensing information by attaching a wearable terminal on the runner and sensing a running pitch, a stride, and the like. As an example of such a system, an information processing apparatus disclosed in Patent Document 1 below can be exemplified.

### CITATION LIST

### Patent Document

Patent Document 1: Japanese Patent Application Laid-Open No. 2016-214499

### SUMMARY OF THE INVENTION

Problems to be Solved by the Invention

A running form is one of important elements of a “running style” in running. The running form is a generic term including a posture, a step pattern, swing of an arm, and the like of a runner who is running. If the quality of the running form, in other words, the state of the running form can be grasped and the runner can obtain an appropriate instruction and training method on the basis of the grasped information, the runner can learn a preferred running form. However, since the state of the running form is grasped by confirming an image of the runner who is running, it is difficult for the runner to grasp the state of the running form of the runner in real time. Moreover, in order to obtain such an image, it is necessary to request a third party to capture an image or to prepare a dedicated imaging system. Therefore, it is difficult for ordinary people who are not athletes to obtain the image of the runner during running. Therefore, a method has been required which can feed back the state of the running form of the runner to the runner in real time without using an image.

Therefore, in the present disclosure, a novel and improved information processing apparatus, information processing method, and program are proposed which can feed back a running and walking state to a user in real time and can be easily used.

### Solutions To Problems

According to the present disclosure, an information processing apparatus is provided that includes a sensing information acquisition unit that acquires sensing information from a single or a plurality of sensors worn on a body of a user who is running or walking, an estimation unit that estimates a grounding state of a foot of the user from the sensing information, and a notification unit that notifies information regarding a running and walking state of the user on the basis of the estimated grounding state.

Furthermore, according to the present disclosure, an information processing method is provided that includes acquiring sensing information from a single or a plurality of sensors worn on a body of a user who is running or walking, estimating a grounding state of a foot of the user from the sensing information, and notifying information regarding a running and walking state of the user on the basis of the estimated grounding state.

Moreover, according to the present disclosure, a program is provided that makes a computer implement a function for acquiring sensing information from a single or a plurality of sensors worn on a body of a user who is running or walking, a function for estimating a grounding state of a foot of the user from the sensing information, and a function for notifying information regarding a running and walking state of the user on the basis of the estimated grounding state.

### Effects of the Invention

As described above, according to the present disclosure, an information processing apparatus, an information processing method, and a program can be provided which can feed back a running and walking state to a user in real time and can be easily used.

Note that the above effects are not necessarily limited, and any effect that has been described in the present specification or other effect indicated which may be found from the present specification may be obtained together with or instead of the above effects.

### BRIEF DESCRIPTION OF DRAWINGS FIG. 1 is an explanatory diagram for explaining an example of a running form.

FIG. 2 is an explanatory diagram for explaining an exemplary configuration of an information processing system 1 according to a first embodiment of the present disclosure.

FIG. 3 is a block diagram illustrating a configuration of a wearable device 20 according to the first embodiment.

FIG. 4 is an explanatory diagram illustrating an example of an appearance of the wearable device 20 according to the first embodiment.

FIG. 5 is an explanatory diagram illustrating another example of the appearance of the wearable device 20 according to the first embodiment.

FIG. 6 is a diagram for explaining wearing states of the wearable devices 20 according to the first embodiment.

FIG. 7 is a block diagram illustrating a configuration of a server 30 according to the first embodiment.

FIG. 8 is an explanatory diagram for explaining an example of machine learning according to the first embodiment.

FIG. 9 is an explanatory diagram for explaining an example of an operation of an estimation unit 330 according to the first embodiment.

FIG. 10 is an explanatory diagram for explaining an example of a determination unit 332 according to the first embodiment.

FIG. 11 is a block diagram illustrating a configuration of a user terminal 70 according to the first embodiment.

FIG. 12 is a sequence diagram for explaining an example of an information processing method according to the first embodiment.

FIG. 13 is an explanatory diagram for explaining an example of a display screen according to a modification of a first example of the first embodiment.

FIG. 14 is an explanatory diagram for explaining an example of a display screen according to a second example of the first embodiment.

FIG. 15 is an explanatory diagram (No. 1) for explaining an example of a display screen according to a modification of the second example of the first embodiment.

FIG. 16 is an explanatory diagram (No. 2) for explaining the example of the display screen according to the modification of the second example of the first embodiment.

FIG. 17 is an explanatory diagram for explaining an example of a display screen according to a third example of the first embodiment.

FIG. 18 is a flowchart for explaining an example of an information processing method according to a second embodiment of the present disclosure.

FIG. 19 is an explanatory diagram for explaining an example of an operation of an information selection unit 334 according to the second embodiment.

FIG. 20 is an explanatory diagram for explaining an example of a display screen according to the second embodiment.

FIG. 21 is a block diagram illustrating an exemplary hardware configuration of an information processing apparatus 900 according to an embodiment of the present disclosure.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configuration are denoted with the same reference numeral so as to omit redundant description.

Furthermore, in the present specification and the drawings, there is a case where multiple components having substantially the same or similar functional configuration are distinguished from each other by attaching different numerals after the same reference. However, in a case where it is not necessary to particularly distinguish the multiple components having substantially the same or similar functional configuration from each other, only the same reference numeral is applied. Furthermore, there is a case where components similar to each other in different embodiments are distinguished from each other by adding different alphabets after the same reference numeral. However, in a case where it is not necessary to particularly distinguish the similar components from each other, only the same reference is applied.

Note that the description will be made in the following order.

1. History in creation of embodiments according to present disclosure

1.1. Background before embodiments according to present disclosure are created

1.2. History in creation of embodiments according to present disclosure

2. First embodiment

2.1. Outline of information processing system 1 according to first embodiment

2.2. Configuration of wearable device 20 according to first embodiment

2.3. Configuration of server 30 according to first embodiment

2.4. Configuration of user terminal 70 according to first embodiment

2.5. Information processing method according to first embodiment

3. Examples according to first embodiment

3.1. First example

3.2. Second example

3.3. Third example

4. Second embodiment

4.1. Configuration of server 30 according to second embodiment

4.2. Information processing method according to second embodiment

5. Summary

6. Regarding hardware configuration

7. Supplement

<<1. History in Creation of Embodiments According to Present Disclosure>>

<1.1. Background Before Embodiments According to Present Disclosure are Created>

First, before the description of the embodiments of the present disclosure, background when the present inventor's have created the embodiments according to the present disclosure will be described. As described above, it is difficult for most people who enjoy sports such as running to obtain an opportunity to receive an advice regarding a “running style” such as a running form from a specialist, and those people often perform running in their own “running style”. Furthermore, in general, a person naturally learns a “running style” in an early childhood of two or three years old, and then, learns a “running style” as an adult while developing experience of various sports or the like according to growth. Even in such a growing process, there are not many opportunities for receiving the specialized instruction regarding the “running style” through classes of schools and the like.

Furthermore, for example, a preferred “running style” exists according to a running distance such as a long distance and a short distance, a condition of a running route such as a flatland, mountains, and sandy ground, and the kind of sports. Therefore, if not only athletes but also ordinary people who enjoy sports can learn the preferred “running style”, it is possible to “easily” run, that is, run “with fun”, and in addition, to reduce injuries occurred during running. Then, if the preferred “running style” can be easily learned, the opportunities of people to enjoy sports increase, and in addition, for people who are not familiar with sports in dairy life, enhancement motivation to enjoy sports can be expected. Moreover, if the opportunities for enjoying the sports increase, the increase further enhances health of people.

By the way, as described above, one of the important elements of the “running style” is a running form such as a posture, steps of feet, and swinging of arms of the runner who is running. Therefore, if the runner can grasp the quality of the running form and obtain an appropriate instruction and training method based on the grasped information, a preferred running form can be learned. Then, since to improve the running form of their own “running style” means to alter the running form which has been used over years, the improvement is a big challenge for the runner. However, the improvement is very effective to “enjoy” running. Furthermore, the preferred running form can be more effectively improved by improving the running form while the runner who is running grasps the state of the running form in real time than by grasping the state of the running form by the runner after running and examining the improvement method.

However, since the running form can be usually grasped by confirming an image of the runner who is running, the runner has not been able to grasp the state of the running form of the runner in real time. Therefore, a running image of the runner is confirmed after running and the improvement method of the running form of the runner is examined. Accordingly, it is difficult to effectively improve the running form by the runner alone. Furthermore, the runner can grasp the running form by being instructed by a coach on the basis of the experience. However, since the state of the running form based on the experience of the coach is transmitted according to feeling of the coach, it may be difficult for the runner to grasp the running form of the runner.

Furthermore, in order to acquire such an image, there is a case where it is necessary to prepare a dedicated imaging system, and it is difficult for ordinary people who are not athletes to prepare such a system. Moreover, it is considered to grasp the running form of the runner from the image, transmit the running form to the runner who is running in real time, and provide a third party who instructs the runner. However, there is a case where it is difficult for people other than athletes to secure such a third party. In addition, in a case where the provided third party is not a person who technically learns the sports, it is difficult to properly transmit, the information to and instruct the runner. Moreover, even though a specialized coach can be secured as a third party, the transmission of the state of the running form and the instruction to improve the running form are sensuously made and lack details. Therefore, it is difficult for the runner to understand and practice content instructed by the third party. Furthermore, grounding of a sole of the runner and the like in the running form can be grasped by making the runner run on a force plate. However, it is difficult to provide the force plate for a long distance in accordance with a running distance of the runner. Therefore, it is difficult for the runner to grasp a grounding state of the sole of the runner in actual long-distance running.

In other words, for ordinary people other than athletes, it is difficult to learn the preferred running form. Moreover, regarding the instruction by the coach, an objective instruction method is not established. Therefore, a large number of points can be improved. Therefore, in view of such a situation, the present inventors have diligently studied to realize a system capable of feeding back the state of the running form to the runner in real time. If such a system can be constructed, ordinary people can easily learn a preferred running form. For example, a preferred “running style” can be easily learned, for example, through jogging performed in classes of schools or the like and in daily life.

<1.2. History in Creation of Embodiments According to Present Disclosure>

By the way, when the present inventors have diligently studied about the running form in a long distance running such as jogging and marathon, it is acknowledged that the quality of the running form has a high correlation with following two indexes. One of the indexes is a grounding state of a foot during running, and another index is muscle elastic characteristic of the foot. In the following description, the two indexes acknowledged by the present inventors will be described with reference to FIG. 1. FIG. 1 is an explanatory diagram for explaining an example of the running form and schematically illustrates a body posture of a person who is running. For easy understanding, arms and feet, the trunk, and the like of the person who is running are expressed by lines.

The grounding state of the foot during running is how the sole has contact with the ground in each step in the running, and mainly, the state can be determined depending on a position of a portion in the sole grounded first. More specifically, the grounding state mainly includes three types, i.e., a state where the foot has contact with the ground from the heel, a state where the foot has contact with from an entire sole, and a state where the foot has contact with from the toe. Note that a general runner often has contact with the ground from the heel or the entire sole in a long-distance running, and it is said that most top long-distance runners have contact with the ground from the toes. In the following description, the grounding state of a general runner, that is, the grounding from the heel and the grounding from the entire sole will be described.

As illustrated in the left figure of FIG. 1, in the grounding from the heel, the runner lands in front of the center of gravity of the user's body. In particular, when the runner attempts to ground in front of the user's body, the user naturally has contact with the ground from the heel. In such a grounding state, since the runner has contact with the ground in front of the center of gravity of the body of the runner, an axis of the grounded foot extending from the sole to the thigh inclined backward, and a force from the front to the back is applied to the foot. Therefore, the runner is braked at each time of grounding, and the runner is not capable of smoothly stepping forward in next step. Moreover, at the time of grounding from the heel, a load is easily applied to the muscles of the foot due to an inclination of the foot when having contact with the ground forward. The grounding from the heel has disadvantageous in a case where the runner attempts to run for a long distance. Furthermore, a grounding time from a time when the heel has contact with the ground to a time when the runner kicks the ground and the sole is separated from the ground becomes longer than the grounding from the entire sole as described later, and a time when the muscles of the foot work becomes longer according to the grounding time. Therefore, the load to the muscles of the foot increases. Therefore, in the long-time running such as running, it cannot be said that the grounding from the heel is not a preferable grounding state.

On the other hand, as illustrated in the right figure of FIG. 1, in the grounding from the entire sole, the runner has contact with the ground below the center of gravity of the runner's body. In such grounding from the entire sole, the axis of the grounded foot extending from the sole to the thigh extends nearly perpendicular to the ground, and the runner is not braked each time when the runner has contact with the ground. Therefore, the runner can smoothly step forward in next step. Moreover, since the center of gravity of the runner's body is positioned on the grounded foot, an impact from the ground can be absorbed by not only the foot but also the entire body of the user, and the load to the muscles of the foot can be reduced. In addition, in the grounding from the entire sole, since a vertical movement of the center of gravity of the body of the runner who is running is naturally reduced, the impact from the ground is reduced, and the load to the runner's body can be reduced. Furthermore, the grounding time from the time when the heel has contact with the ground to the time when the runner kicks the ground and the sole is separated from the ground is shorter than that in the grounding from the heel. Therefore, the load to the muscles of the foot can be further reduced. Therefore, in the long-distance running such as running, it can be said that the grounding from the entire sole is a preferable grounding state.

In other words, in the long-distance running such as jogging and marathons, it can be said that the grounding state in which the runner has contact with the ground from the entire sole is a more preferred running form than that in the grounding state in which the runner has contact with the ground from the heel. In this way, the quality of the running form has a correlation with the grounding state of the foot during running, and it is possible to determine the state of the running form by grasping the grounding state of the foot during running. Note that, the grounding state described above can be directly grasped by analyzing an image of the runner who is running and by providing a force plate and the like under the runner who is running and analyzing measurement results acquired from the force plate. However, as described above, since it is difficult to provide the imaging system for imaging the running image of the runner and the force plate for a long distance, it is difficult for the user to directly grasp the grounding state. Therefore, an estimation technique for estimating the grounding state is important.

Next, the elastic characteristic of the muscles of the foot (muscle elastic characteristics) will be described. A physical exercise such as running is performed by performing a cycle exercise for stretching and shortening muscles of the lower legs and the muscle-tendon complex such as Achilles tendon. More specifically, in a case of running, the muscle-tendon complex of the foot is stretched at the time of the grounding, and elastic energy is accumulated in the muscle-tendon complex. Next, the muscle-tendon complex is contracted at the time when the runner kicks the grounded foot to the rear side of the runner's body, and the accumulated elastic energy is released at once. The runner generates a part of a driving force in running by using the released elastic energy to kick the ground. Therefore, if the elastic energy can be efficiently accumulated and the accumulated elastic energy can be efficiently used when the runner kicks the ground, it can be said that the runner can run as efficiently obtaining a high driving force. In other words, it can be said that running economy can be enhanced by efficiently using the elastic characteristics of the muscles of the foot (muscle elastic characteristics). Note that the elastic energy described above can be directly grasped by providing the force plate and the like under the runner who is running and analyzing a pressure acquired from the force plate.

Note that, in general, in order to efficiently use the elastic characteristics of the muscles of the foot as described above during running exercise, most top runners effectively use a stretch-shorter cycle (SSC) of the muscle-tendon complex of the foot.

In other words, regardless of the short distance or the long distance, it can be said that a running form which can efficiently accumulate and release the elastic energy is a preferred running form in the running exercise. Therefore, it is possible to determine the quality of the running form by grasping the usage of the elastic characteristics of the muscles of the foot.

Moreover, as the present inventors has continued the study, it is found that the grounding state and the muscle elastic characteristics of the foot which are two indexes having the correlation with the state of the running form can be estimated from sensing information acquired from an inertial measurement unit. Specifically, the inertial measurement unit is a device which detects three-axis acceleration, three-axis angular speed, and the like generated by exercise and includes an acceleration sensor, a gyro sensor, and the like. The inertial measurement unit can be used as a wearable device by wearing the inertial measurement unit on a part of the body or the like as a motion sensor. In recent years, such an inertial measurement unit which can be worn on the body has been widely used and can be easily obtained. Therefore, even a general person can easily use the inertial measurement unit. Moreover, since the inertial measurement unit can be worn on the body, the inertial measurement unit does not interfere with running of the runner, and a running place of the runner and the like is not limited. These points are advantages of the inertial measurement unit. Then, such an inertial measurement unit is worn on the body of the runner and acquires the sensing information generated by movement of the runner who is running. According to the study of the present inventors, it is clarified that the two indexes can be estimated by analyzing the acquired sensing information by using a database acquired by machine learning and the like.

Therefore, by focusing on the acknowledgement, the present inventors have considered that the runner can grasp the state of the running form in real time without using an image and have created the embodiments of the present disclosure. In other words, according to the embodiments of the present disclosure to be described below, since an image is not used, it is possible to provide a system which can feed back the state of the running form to the runner who is running in real time and can be easily used. More specifically, in the embodiments of the present disclosure, the two indexes including the grounding state of the foot and the elastic characteristics of the muscles of the foot are estimated on the basis of the sensing information acquired by the wearable sensor worn on the body of the runner. Moreover, in the present embodiment, the state of the running form of the runner is determined on the basis of the estimation result. Hereinafter, a configuration and an information processing method according to the embodiments of the present disclosure will be sequentially described in detail.

Note that, in the following description, a runner who runs as wearing the wearable device 20 according to the embodiments of the present disclosure as described below is referred to as a user. Furthermore, in the following description, a user, who uses the information processing system 1 according to the embodiments of the present disclosure, other than the above-described user as referred to as a third party (other user).

<<2. First Embodiment>>

<2.1. Outline of Information Processing system 1 According to First Embodiment>

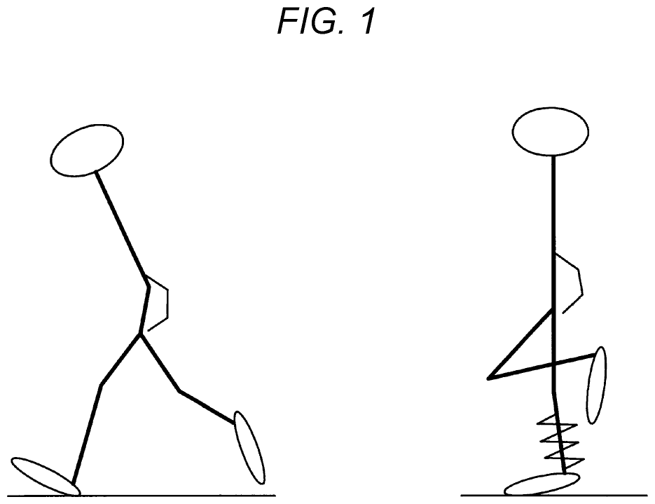

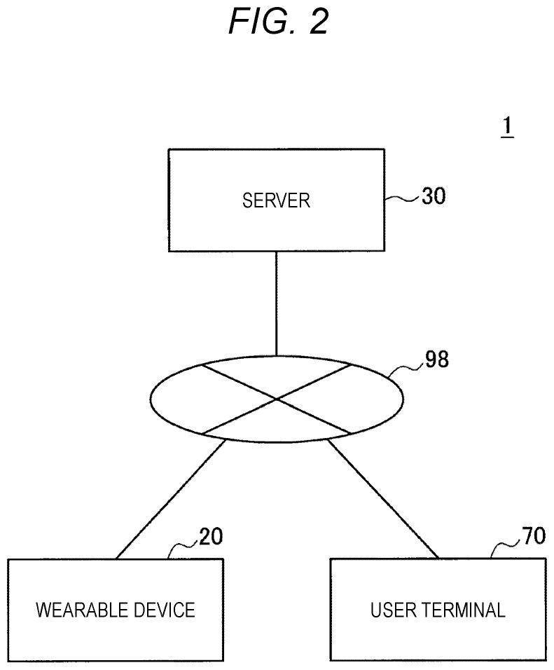

Next, a configuration according to an embodiment of the present disclosure will be described. First, the configuration according to the embodiment of the present disclosure will be described with reference to FIG. 2. FIG. 2 is an explanatory diagram for explaining an exemplary configuration of an information processing system 1 according to the present embodiment.

As illustrated in FIG. 2, the information processing system 1 according to the present embodiment includes a wearable device 20, a server 30, and a user terminal 70 which are communicably connected to each other via a network 98. Specifically, the wearable device 20, the server 30, and the user terminal 70 are connected to the network 98 via a base station and the like (not illustrated) (for example, base station of mobile phones, access point of wireless LAN, and the like). Note that a communication method used in the network 98 can be any methods regardless whether the method is a wired or wireless method. However, since the wearable device 20 is worn by a user who is running, it is preferable to use wireless communication so as not to interfere with running of the user. Furthermore, in the present embodiment, it is desirable to apply a communication method capable of maintaining a stable operation so that the server 30 can stably provide information to the user and a third party other than the user by the present embodiment.

The wearable device 20 is a device which can be worn on a part of a body of the user who is running or an implant device inserted into the body of the user. More specifically, as the wearable device 20, various types of wearable devices such as a Head Mounted Display (HMD) type, an ear device type, an anklet type, a bracelet type, a collar type, an eyewear type, a pad type, a badge type, and the like a cloth type can be employed. Moreover, the wearable device 20 incorporates a single or a plurality of sensors so as to acquire sensing information used to determine a state of a running form of the user who is running. Note that the wearable device 20 will be described later in detail.

The server 30 is configured of, for example, a computer or the like. For example, the server 30 is owned by a service provider which provides a service by the present embodiment, and provides the service to each user or each third party. Specifically, the server 30 grasps the state of the running form of the user and provides a service such as a notification of the state of the running form and a notification of an advice such as a method for improving the running form to the user. Note that the server 30 will be described later in detail.

The user terminal 70 is a terminal for notifying the user or the third party other than the user of information from the server 30 and the like. For example, the user terminal 70 can be a device such as a tablet, a smartphone, a mobile phone, a laptop Personal Computer (PC), a notebook PC, and an HMD.

Note that, in FIG. 2, the information processing system 1 according to the present embodiment is illustrated as an information processing system 1 including the single wearable device 20 and the single user terminal 70. However, the present embodiment is not limited to this. For example, the information processing system 1 according to the present embodiment may include the plurality of wearable devices 20 and user terminals 70. Moreover, the information processing system 1 according to the embodiment may include, for example, another communication device and the like such as a relay device which is used when the sensing information is transmitted from the wearable device 20 to the server 30.

<2.2. Configuration of Wearable Device 20 According to First Embodiment>

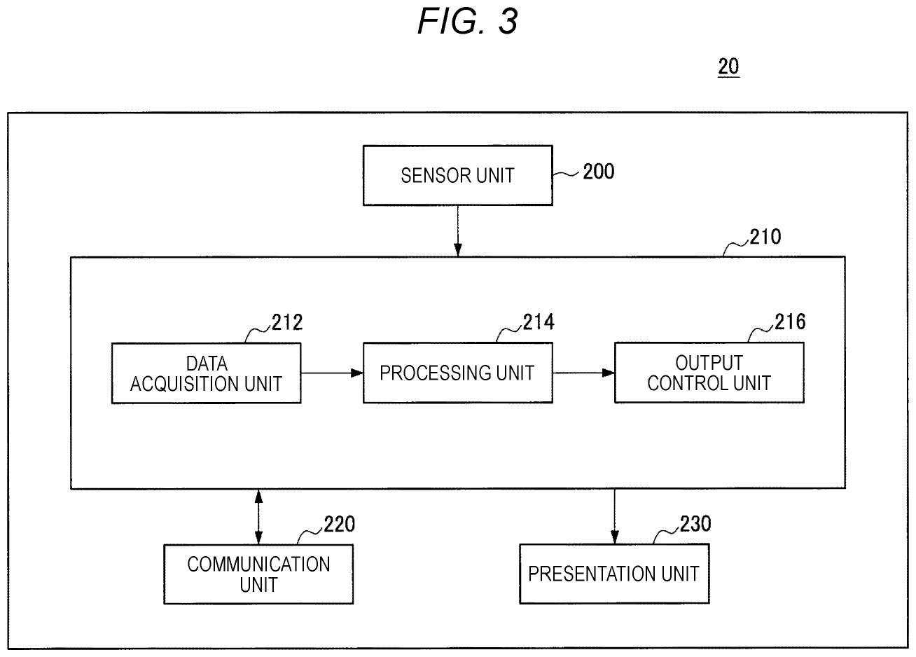

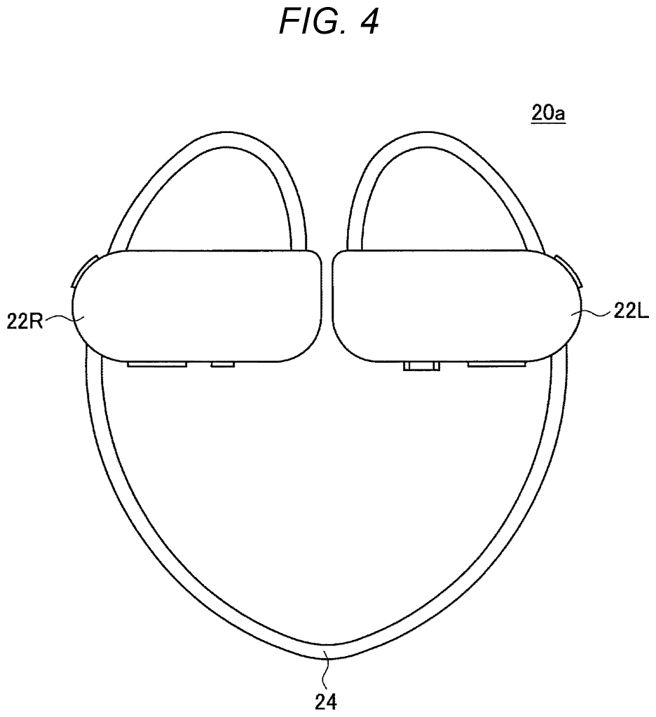

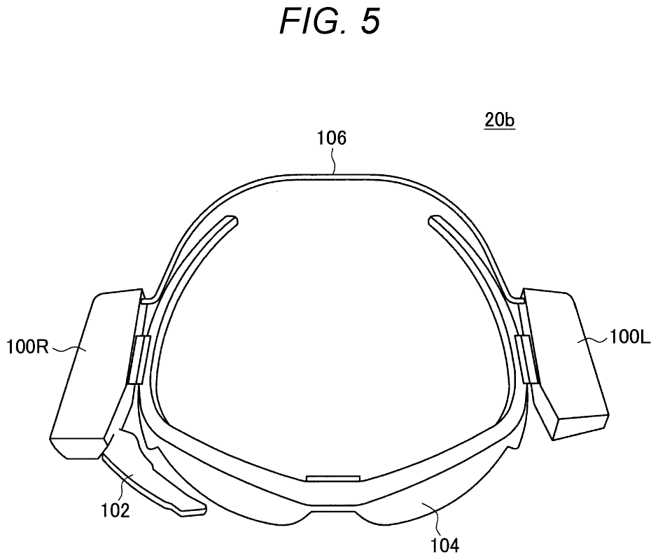

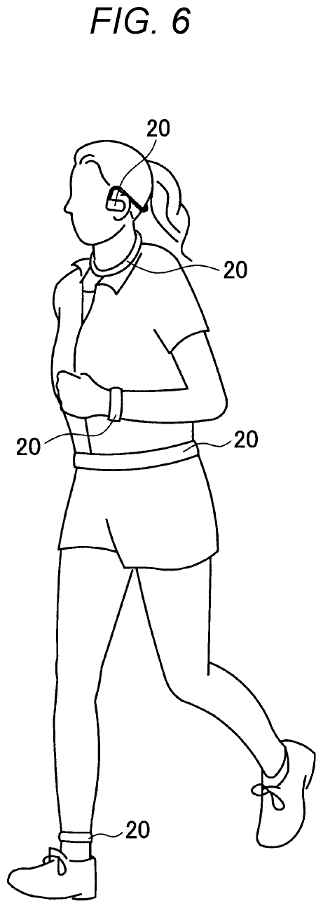

Next, the configuration of the wearable device 20 according to the embodiment of the present disclosure will be described with reference to FIGS. 3 to 6. FIG. 3 is a block diagram illustrating the configuration of the wearable device 20 according to the present embodiment. FIGS. 4 and 5 are explanatory diagrams illustrating examples of an appearance of the wearable device 20 according to the present embodiment. Moreover, FIG. 6 is a diagram for explaining wearing states of the wearable devices 20 according to the present embodiment.

As illustrated in FIG. 3, the wearable device 20 mainly includes a sensor unit 200, a main control unit 210, a communication unit 220, and a presentation unit 230. Each functional unit of the wearable device 20 will be described in detail below.

(Sensor Unit 200)

The sensor unit 200 is a sensor which is provided in the wearable device 20 worn on the body of the user and detects a user's running movement. The sensor unit 200 is realized by, for example, a single or a plurality of sensor devices such as an acceleration sensor, a gyro sensor, and a geomagnetic sensor, detects a change in acceleration, an angular speed, and the like generated according to the movement of the user, and generates a single or a plurality of pieces of sensing information indicating the detected change. The single or the plurality of pieces of sensing information acquired by the sensor unit 200 is output to the main control unit 210 as described later. Furthermore, the sensor unit 200 may include various other sensors such as a Global Positioning System (GPS) receiver, a heart rate sensor, an atmospheric pressure sensor, a temperature sensor, and a humidity sensor.

(Main Control Unit 210) The main control unit 210 is provided in the wearable device 20 and can control each block of the wearable device 20. The main control unit 210 is realized by hardware, for example, a Central Processing Unit (CPU), a Read Only Memory (ROM), a Random Access Memory (RAM), and the like. Furthermore, the main control unit 210 can function as a data acquisition unit 212, a processing unit 214, and an output control unit 216. Hereinafter, the functions of the main control unit 210 according to the present embodiment will be described in detail.

The data acquisition unit 212 controls the sensor unit 200 to acquire the sensing information output from the sensor unit 200, and outputs the acquired sensing information to the processing unit 214. Furthermore, the data acquisition unit 212 may have a built-in clock mechanism (not illustrated) which grasps accurate time, associate the sensing information with time when the sensing information is acquired, and output the sensing information to the processing unit 214. The processing unit 214 converts the sensing information output from the data acquisition unit 212 into a predetermined format which can be transmitted via the network 98 and outputs the converted information to the output control unit 216. Moreover, the output control unit 216 controls the communication unit 220 as described later so as to transmit the sensing information in the predetermined format output from the processing unit 214 to the server 30.

(Communication Unit 220)

The communication unit 220 is provided in the wearable device 20 and can exchange information with an external device such as the server 30. In other words, it can be said that the communication unit 220 is a communication interface having a function for exchanging data. Furthermore, by exchanging data with the server 30 as described later, for example, the communication unit 220 can notify the server 30 of a type of a device which functions as the presentation unit 230 of the wearable device 20. Note that the communication unit 220 is realized by a communication device such as a communication antenna, a transmission and reception circuit, and a port.

(Presentation Unit 230)

The presentation unit 230 is a device used to present information to the user and, for example, outputs various information to the user by an image, voice, light, vibration, or the like. The presentation unit 230 is realized by a display (image display device) , a speaker (voice output device), an earphone (voice output device), a light emitting unit, a vibration module (vibration device), and the like. Moreover, the presentation unit. 230 may be realized by a video output terminal, a voice output terminal, and the like.

Furthermore, the wearable device 20 may include an input unit which is not illustrated. The input unit has a function for receiving an input of data and a command to the wearable device 20. More specifically, the input unit is realized by a touch panel, a button, a switch, a key, a keyboard, a microphone, an image sensor, and the like.

Furthermore, in the present embodiment, it is possible to divide the function of the sensor unit 200 from the function of the presentation unit 230 and provide two different wearable devices 20. In this way, since the size of the configuration of the wearable device 20 having the function of the sensor unit 200 can be reduced, it is possible to wear the wearable device 20 on various parts of the body of the user.

As described above, as the wearable device 20, various types of wearable devices such as an HMD type, an ear device type, an anklet type, a bracelet type, a collar type, an eyewear type, a pad type, a badge type, and a cloth type can be employed. In FIG. 4, an example of the appearance of the wearable device 20 is illustrated. A wearable device 20a illustrated in FIG. 4 is a neckband type wearable device. The wearable device 20a mainly includes left and right main body portions 221 and 22R and a neck band 24 for connecting the main body portions 221 and 22R. The main body portions 22L and 22R incorporate, for example, at least a part of the sensor unit 200, the main control unit 210, the communication unit 220, and the presentation unit 230 in FIG. 3. Furthermore, an earphone (not illustrated) which functions as the presentation unit 230 is built in each of the main body portions 22L and 22R, and the user can listen to voice information and the like by wearing the earphones on both ears.

Moreover, in FIG. 5, an example of the appearance of the wearable device 20 is illustrated. A wearable device 20b illustrated in FIG. 5 is an eyewear type wearable device. The wearable device 20b includes left and right main body portions 100L and 100R, a display 102, a lens 104, and a neck band 106 for connecting the main body portions 1001 and 100R. The main body portions 1001 and 100R incorporate, for example, at least a part of the sensor unit 200, the main control unit 210, the communication unit 220, and the presentation unit 230 in FIG. 3. Furthermore, the display 102 includes an organic Electro Luminescence (EL) display and the like.

Therefore, the user can see surroundings via the lens 104 in a state where the user wears the wearable device 20b, and the user can see a screen. displayed on the display 102 with one eye.

Furthermore, as illustrated in FIG. 6, the single or the plurality of wearable devices 20 is worn on various parts of the user such as the head, the neck, the waist, the wrist, and the ankle. Furthermore, the wearable device 20 may be attached to or embedded in running shoes of the user and the like. Moreover, in FIG. 6, a belt-like wearable device 20 is worn on the waist of the user. However, the shape of the wearable device 20 worn on the waist is not limited to this. For example, the wearable device 20 may have a shape of a pedometer (Manpokei (registered trademark)) which can be hooked to a belt. More specifically, the wearable device 20 is provided on the waist, the thigh close to the hip, the knee joint, the ankle, and the like of the user so as to acquire various sensing information used to grasp the state of the running form. Furthermore, in the present embodiment, it is sufficient that the wearable device 20 is worn on a part where the wearable device 20 does not interfere with running of the user who is running, and the wearing position is not limited. However, in order to acquire various sensing information used to grasp the state of the running form with high accuracy, it is preferable that the wearable device 20 be worn on the waist and the like close to the center of gravity of the user's body.

<2.3. Configuration of Server 30 According to First Embodiment>

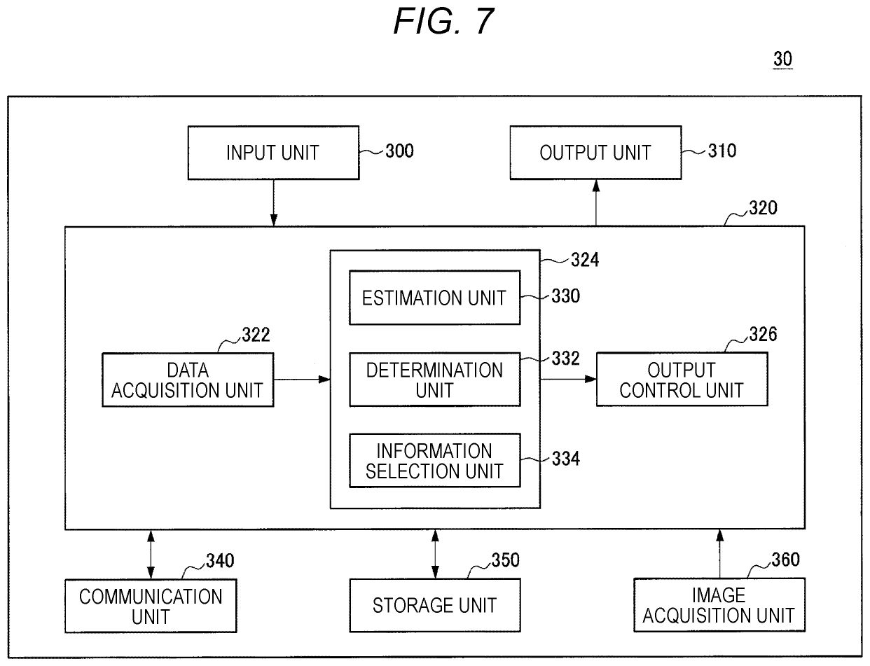

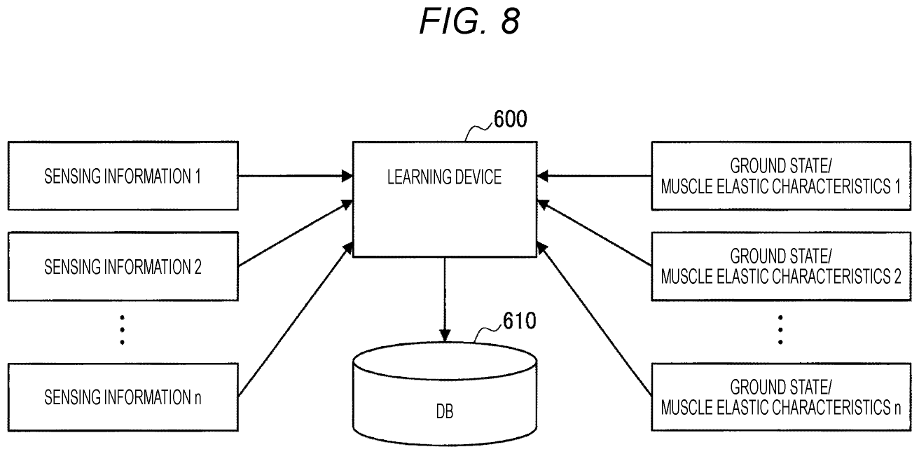

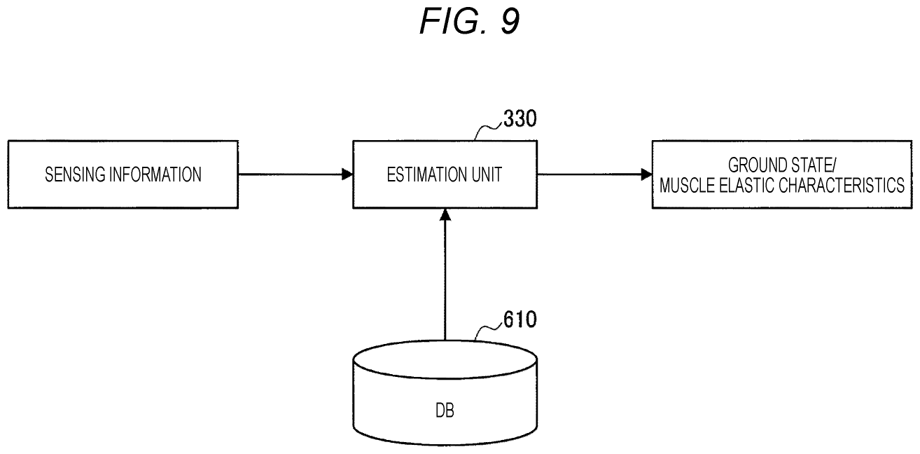

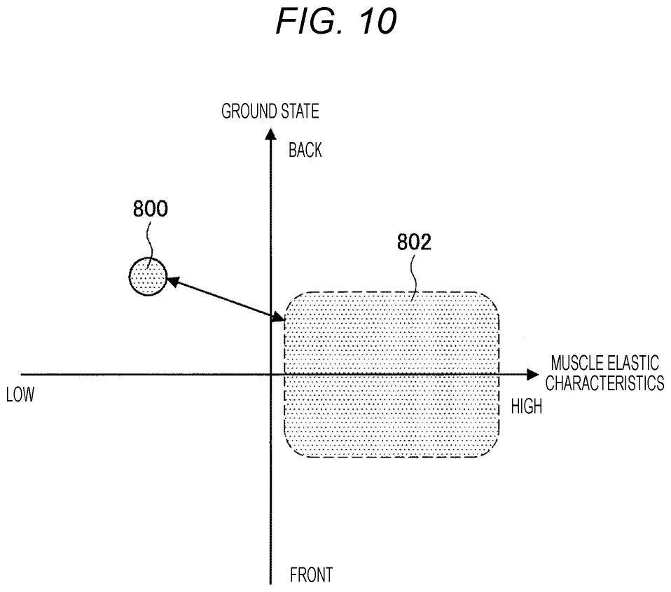

Next, the configuration of the server 30 according to the embodiment of the present disclosure will be described with reference to FIGS. 7 to 10. FIG. 7 is a block diagram illustrating the configuration of the server 30 according to the present embodiment. FIG. 8 is an explanatory diagram for explaining an example of machine learning according to the present embodiment. FIG. 9 is an explanatory diagram for explaining an example of an operation of an estimation unit 330 according to the present embodiment. Moreover, FIG. 10 is an explanatory diagram for explaining an example of an operation of a determination unit 332 according to the present embodiment.

As described above, the server 30 is configured of, for example, a computer and the like. As illustrated in FIG. 7, the server 30 mainly includes an input unit 300, an output unit 310, a main control unit 320, a communication unit 340, a storage unit 350, an image acquisition unit (imaging information acquisition unit) 360. Each functional unit of the server 30 will be described in detail below.

(Input Unit 300)

The input unit 300 receives an input of data and a command to the server 30. More specifically, the input unit 300 is realized by a touch panel, a keyboard, and the like.

(Output Unit 310)

The output unit 310 includes, for example, a display, a speaker, a video output terminal, a voice output terminal, and the like and outputs various information by an image, voice, and the like.

(Main Control Unit 320)

The main control unit 320 is provided in the server 30 and can control each block of the server 30. The main control unit 320 is realized by hardware, for example, a CPU, a ROM, a RAM, and the like. Furthermore, the main control unit 320 can function as a data acquisition unit (sensing information acquisition unit) 322, a processing unit 324, and an output control unit 326. Hereinafter, the functions of the main control unit 320 according to the present embodiment will be described in detail.

The data acquisition unit 322 acquires the sensing information transmitted from the wearable device 20 and outputs the acquired sensing information to the processing unit 324.

The processing unit 324 processes the sensing information output from the data acquisition unit 322 and estimates a grounding state of a foot of the user and the like from the sensing information. Moreover, the processing unit 324 determines the state of the running form of the user (running state) on the basis of the estimated grounding state and the like. Specifically, the processing unit 324 functions as the estimation unit 330, the determination unit 332, and an information selection unit (notification unit) 334 so as to realize these functions. Hereinafter, the functions of the processing unit 324 according to the present embodiment will be described in detail.

The estimation unit 330 estimates the grounding state of the foot of the user and elastic characteristics (muscle elastic characteristics) of muscles by applying a predetermined algorithm on the basis of the sensing information transmitted from the wearable device 20. Then, the estimation unit 330 outputs the estimation results of the grounding state and the muscle elastic characteristics to the determination unit 332, the information selection unit 334, and the storage unit 350 as described later.

More specifically, for example, the estimation unit 330 estimates the grounding state and the muscle elastic characteristics by using a DB 610 (refer to FIG. 8) acquired by machine learning below.

First, the runner wears the wearable device 20 on a part of the body so as to acquire information used to construct the DB 610 and runs on a force plate. At this time, the wearable device 20 acquires various sensing information generated by the movement of the runner who is running. At the same time, the force plate measures a relative grounding position of the foot of the user with respect to the trunk of the user who is running, a portion of the grounded sole, a pressure applied by grounding the sole, a grounding time, and the like in addition, it is possible to capture an image of the runner who is running and acquire information such as an inclination of the trunk of the user, and the grounding state of the foot from the image. Note that the runner may be a user who actually uses the wearable device 20 or may be a person other than the user as a runner who acquires the information used to construct the DB 610. In a case where at is assumed that the runner be a user, estimation accuracy regarding the grounding state and the like estimated by the estimation unit 330 can be enhanced. On the other hand, in a case where the runner is a person other than the user, it is not necessary for the user to perform measurements so as to acquire the information used to construct the DB 610. Therefore, the user can easily use the information processing system 1 according to the present embodiment. Furthermore, it is assumed that attribute information and the like (for example, information such as sex, age, height, and weight) of the runner be acquired in advance.

Then, for example, the sensing information, the measurement result, and the like acquired as described above are input to the server 30 or other information processing apparatus which is not illustrated, and a learning device 600 included in the processing unit 324 or the like of the server 30 is made to perform machine learning. Specifically, as illustrated in FIG. 8, it is assumed that the supervised learning device 600 such as a support vector regression, and a deep neural network be provided in the server 30 or the other information processing apparatus. The sensing information acquired from the wearable device 20 and the measurement result (grounding state and muscle elastic characteristics) acquired by using the force plate and the like are input to the learning device 600 respectively, as a teacher signal and an input signal, and the learning device 600 performs machine learning regarding a relation between these pieces of information according to a predetermined rule. Then, the plurality of pairs of teacher signals and input signals is input to the learning device 600, and the learning device 600 performs machine learning on the inputs so that the learning device 600 constructs the database (DB) 610 storing the relation information indicating the relation between the sensing information, the grounding state, and the like. At this time, the attribute information and the like described above may be input to the learning device 600 as information at the time when input targets are grouped and information used to analyze the measurement results. Furthermore, in the present embodiment, the learning device 600 may use a semi-supervised learning device and a weakly-supervised learning device.

Moreover, as illustrated in FIG. 9, the estimation unit 330 can estimate the grounding state and the muscle elastic characteristics from the sensing information of the user newly acquired from the wearable device 20 on the basis of the DB 610 acquired by machine learning by the learning device 600. In this way, in the present embodiment, the grounding state and the muscle elastic characteristics can be estimated according to the sensing information from the wearable device 20 without using an imaging device, a force plate, and the like. Moreover, as described above, since the grounding state and the muscle elastic characteristics are indexes having a high correlation with the state of the running form, it is possible to determine the state of the running form by using these indexes.

Note that, the estimation method of the estimation unit 330 is not limited to the method using machine learning described above, other estimation method may be used in the present embodiment. In the present embodiment, for example, in a case where one piece of the sensing information has a significantly high correlation with the grounding state, in other words, the position of the portion in the sole grounded first, the grounding state may be calculated by inputting the sensing information into an expression indicating the correlation relation.

The determination unit 332 determines the state of the running form of the user on the basis of the estimation result of the estimation unit 330. Since the state of the running form is grasped by using the index estimated by the estimation unit 330, not an image, in the present embodiment, it is possible to feed back the state of the running form to the user in real time even when no third party images the user who is running. Then, the determination unit 332 outputs the determination result to the information selection unit 334, the storage unit 350, and the like as described later to provide the feedback to the user.

For example, as illustrated in FIG. 10, the determination unit 332 virtually plots the two indexes (grounding state and muscle elastic characteristics) estimated by the estimation unit 330 on XY coordinates. In FIG. 10, the plotted marker is indicated as a marker 800. Specifically, on the XY coordinate axes in FIG. 10, an axis indicating the muscle elastic characteristics is indicated as the X axis, and the elastic energy used for running increases from the left side of the X axis toward the right side in FIG. 10. Furthermore, on the XY coordinate axes in FIG. 10, an axis indicating the grounding state is indicated as the Y axis, and the position of the portion in the sole grounded first in a running step moves from the front side to the back side from the lower side to the upper side of FIG. 10. In other words, a case where the marker is illustrated on the lower side of the Y axis in FIG. 10 means a grounding state where a toe is grounded first, and a case where the marker is illustrated on the upper side of the Y axis in FIG. 10 means a grounding state where a heel is grounded first. Moreover, a case where the marker is illustrated at the center of the Y axis in FIG. 10, in other words, near the X axis means a grounding state where the foot of the user is grounded from an entire sole. The determination unit 332 plots the grounding state and the muscle elastic characteristics estimated by the estimation unit 330 on such XY coordinate axes. Moreover, as illustrated in FIG. 10, a predetermined region 802 is illustrated on the XY coordinate axes. The region 802 indicates a range which is a preferable state of the running form. In other words, the region 802 is in a range where the grounding state is assumed as a preferred state and a range where the muscle elastic characteristics are assumed as a preferable state. Therefore, if the coordinates of the marker 800 plotted by the determination unit 332 are positioned in the region 802, it can be said that the state of the running form of the user is excellent.

Furthermore, in a case where the coordinates of the plotted marker 800 are not positioned in the region 802, the determination unit 332 calculates a virtual distance from the marker 800 to the region 802. Moreover, the determination unit 332 can acquire an evaluation point indicating evaluation regarding the quality of the running form by normalizing the calculated distance by using a predetermined value. According to the evaluation point acquired in this way, the user can easily grasp the quality of the running form of the user. More specifically, in a case where the coordinates of the plotted marker are positioned in the region 802, it is assumed that the running form is excellent, and for example, full evaluation points such as 100 points are calculated. In this case, in a case where the coordinates of the plotted marker 600 are not positioned in the region 802, the evaluation point is indicated as a relative value with respect to the full points of 100 points. Therefore, the user can easily grasp the quality of the running form of the user.

Note that, the determination method by the determination unit 332 is not limited to the method described above, and other method may be used in the present embodiment. In the present embodiment, the determination unit 332 may determine the state of the running form by executing statistical processing relative to the estimated indexes (grounding state and muscle elastic characteristics).

Furthermore, in the above description, it has been described that the determination unit 332 determines the state of the running form of the user by using the grounding state and the muscle elastic characteristics. However, the present embodiment is not limited to this. For example, the determination unit 332 may make a determination by using any one of the grounding state and the muscle elastic characteristics. Furthermore, in a case where a grounding time and the like can be acquired, the grounding time may be used as a third index having a correlation with the state of the running form. In this case, the determination unit 332 may plot the grounding state, the muscle elastic characteristics, and the grounding time on the XYZ coordinate axes, and may similarly make a determination. By increasing the number of indexes used by the determination unit 332 in this way, the state of the running form of the user can be determined with higher accuracy.

The information selection unit 334 selects communication data to be transmitted to the wearable device 20 according to the kind of the presentation unit 230 included in the wearable device 20 on the basis of the information from the wearable device 20 acquired from the communication unit 340 described later. Then, the information selection unit 334 outputs the selected data to the output control unit 326 described later. For example, in a case where the presentation unit 230 of the wearable device 20 is a display, the information. selection unit 334 selects data used to control the display to display a predetermined image corresponding to the estimation result of the estimation unit 330, the determination result of the determination unit 332, and the like. Furthermore, in a case where the presentation unit 230 is an earphone, the information selection unit 334 selects data used to control the earphone to output predetermined voice corresponding to the estimation result, the determination result, and the like. Moreover, in a case where the presentation unit 230 is a vibration module, the information selection unit 334 selects data used to control the vibration module to vibrate according to a predetermined vibration pattern according to the estimation result, the determination result, and the like.

The output control unit 326 transmits the data output from the processing unit 312 to the wearable device 20 and the user terminal 70 by controlling the communication unit 340 described later.

(Communication Unit 340)

The communication unit 340 is provided in the server 30 and can exchange information with an external device such as the wearable device 20 and the user terminal 70. Moreover, the communication unit 340 can detect the type of the device which functions as the presentation unit 230 of the wearable device 20 by exchanging data with the wearable device 20. Note that the communication unit 340 is realized by a communication device such as a communication antenna, a transmission and reception circuit, and a port.

(Storage Unit 350)

The storage unit 350 is provided in the server 30 and stores a program, information, and the like used to execute various processing by the main control unit 320 and information acquired by the processing. Note that the storage unit 350 is realized by, for example, a magnetic recording medium such as a Hard Disk (HD), a nonvolatile memory such as a flash memory, and the like.

(Image Acquisition Unit 360)

The image acquisition unit 360 is provided in the server 30 and acquires image data of the user during running from an imaging device such as a video camera (not illustrated). The imaging device can transmit the image data to the server 30 via wired communication or wireless communication. Note that, in the present embodiment, it is not premised that the image data of the user who is running acquired by the image acquisition unit 360 is not used for the estimation by the estimation unit 330 as described above. For example, as described in examples below, the image data is provided to the user or the third party other than the user as additional information. Therefore, in the present embodiment, the image acquisition unit 360 does not need to be provided in the server 30.

<2.4. Configuration of User Terminal 70 According to First Embodiment>

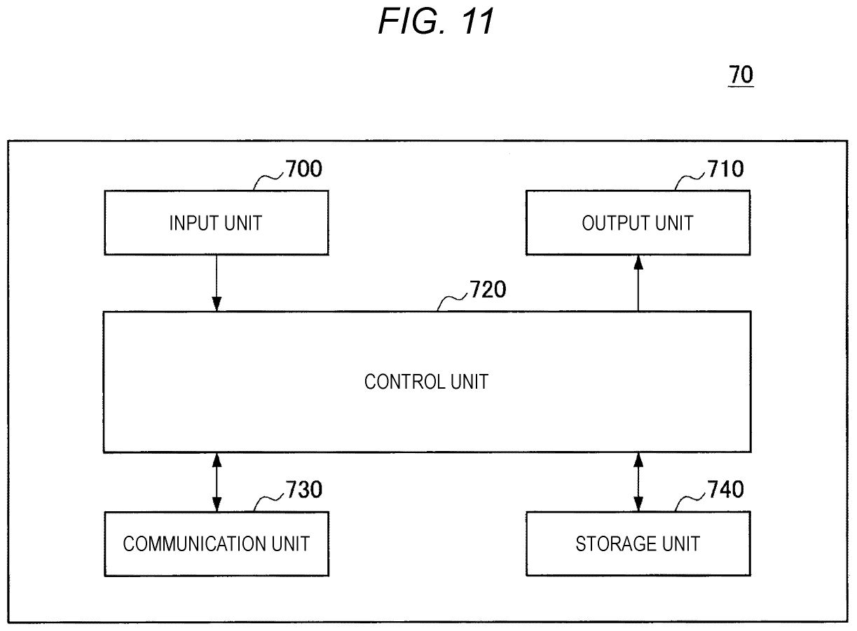

Next, the configuration of the user terminal 70 according to the embodiment of the present disclosure will be described with reference to FIG. 11. FIG. 11 is a block diagram illustrating the configuration of the user terminal 70 according to the present embodiment. As described above, the user terminal 70 is a device such as a tablet, a smartphone, a mobile phone, a laptop type PC, a notebook PC, and an HMD. As illustrated in FIG. 11, the user terminal 70 mainly includes an input unit 700, an output unit 710, a main control unit 720, a communication unit 730, and a storage unit 740. Each functional unit of the user terminal 70 will be described in detail below.

(Input Unit 700)

The input unit 700 receives an input of data and a command to the user terminal 70. More specifically, the input unit 700 is realized by a touch panel, a keyboard, and the like.

(Output Unit 710)

The output unit 710 includes, for example, a display, a speaker, a video output terminal, a voice output terminal, and the like and outputs various information by an image, voice, or the like.

(Main Control Unit 720)

The main control unit 720 is provided in the user terminal 70 and can control each block of the user terminal 70. The main control unit 720 is realized by hardware, for example, a CPU, a ROM, a RAM, and the like.

(Communication Unit 730)

The communication unit 730 can exchange information with an external device such as the server 30. Note that the communication unit 730 is realized by a communication device such as a communication antenna, a transmission and reception circuit, and a port.

(Storage Unit 740)

The storage unit 740 is provided in the user terminal 70 and stores a program and the like used to execute various processing by the main control unit 720 described above and information acquired by the processing. Note that the storage unit 740 is realized by, for example, a magnetic recording medium such as an HD, a nonvolatile memory such as a flash memory, and the like.

<2.5. Information Processing Method According to First Embodiment>

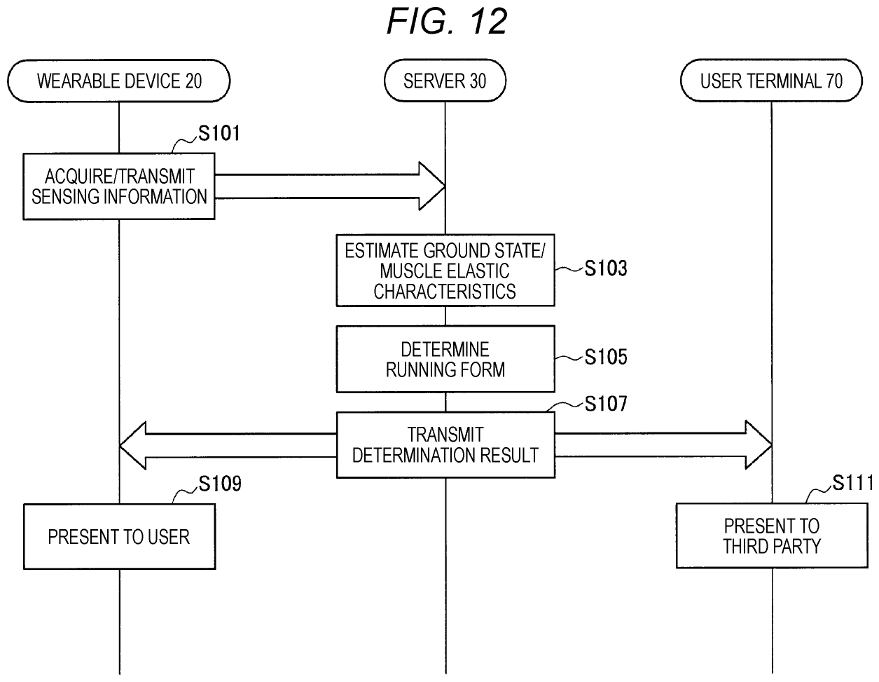

In the above, the configurations of the information processing system 1 according to the present embodiment, the wearable device 20, the server 30, and the user terminal 70 included in the information processing system 1 have been described in detail. Next, an information. processing method according to the present embodiment will be described. As a rough flow of the information processing method, the information processing system 1 acquires the single or the plurality of pieces of sensing information from the single or the plurality of wearable devices 20 worn on the body of the user who is running and estimates the grounding state and the muscle elastic characteristics from the acquired sensing information. Moreover, the information processing system 1 determines the state of the running form of the user from the estimated indexes and presents the determination results and the like to the user or the third party other than the user. The information processing method according to the present embodiment will be described below with reference to FIG. 12. FIG. 12 is a sequence diagram for explaining an example of the information processing method according to the present embodiment. As illustrated in FIG. 12, the information processing method according to the present embodiment includes a plurality of steps from step S101 to step S111. Each step included in the information processing method according to the present embodiment will be described in detail below.

(Step S101)

The wearable device 20 is previously worn on a part of the body of the user before the user runs. When the user starts to run, the sensor unit 200 of the wearable device 20 detects a change in acceleration, an angular speed, and the like generated according to the movement of the user and generates a single or a plurality of pieces of sensing information indicating the detected change. Moreover, the wearable device 20 transmits the generated sensing information to the server 30.

(Step S103)

The server 30 acquires the sensing information from the wearable device 20. The server 30 estimates the grounding state and the muscle elastic characteristics of the foot of the user by applying a predetermined algorithm on the basis of the sensing information.

(Step S105)

The server 30 determines the state of the running form of the user on the basis of the estimation result acquired in step S103 described above.

(Step S107)

The server 30 transmits the determination result. acquired in step S103 described above to the wearable device 20 worn on the user and the user terminal 70 of the user or the third party. Note that, at this time, the server 30 may transmit not only the determination result but also other information such as the estimation result and the history of the estimation result.

(Step S109)

The wearable device 20 presents the determination. result regarding the state of the running form and the like to the user on the basis of the received information. For example, the wearable device 20 presents the determination result or the like to the user by an image, voice, light, vibration, or the like.

(Step S111)

The user terminal 70 presents the determination result or the like regarding the state of the running form to the user or the third party on the basis of the received information. For example, the user terminal 70 presents the determination result and the like to the third party by an image or voice.

As described above, in the first embodiment, the estimation unit 330 can estimate the grounding state and the muscle elastic characteristics from the sensing information acquired from the wearable device 20 on the basis of the DB 610 acquired by machine learning. In this way, the grounding state and the muscle elastic characteristics which are two indexes having a high correlation with the state of the running form can be estimated without using a special device such as the imaging device, and the force plate. Moreover, in the present embodiment, the state of the running form is grasped by using the index estimated by the estimation unit 330, without using an image. Therefore, according to the present embodiment, even though no third party images the user who is running, the state of the running form can be fed back to the user in real time. In other words, according to the present embodiment, a system can be provided which can feed back the state of the running form to the user in real time and can be easily used.

Note that, in the above description, it has been described that the determination unit 332 determines the state of the running form of the user by using the grounding state and the muscle elastic characteristics. However, the present embodiment is not limited to this. For example, the determination unit 332 may make a determination by using any one of the grounding state and the muscle elastic characteristics. Furthermore, in a case where the grounding time and the like can be acquired, determination may be made by using the grounding time as the third index having a correlation with the state of the running form.

<<3. Examples According to First Embodiment>>

The information processing method according to the first embodiment has been described in detail above. Next, an example of information processing according to the first embodiment will be described as indicating specific examples. In the following description, each example will be described focusing on a method for presenting the state of the running form to the user or the third party. Note that the examples described below are merely examples of the information processing according to the first embodiment, and the information processing according to the first embodiment is not limited to the following examples.

<3.1. First Example>

First, a first example will be described which can feed back the state to the running form of the user to the user who is running in real time.

First, in the present example, the user wears the wearable device 20 on a part of the body of the user and runs. As described above, the wearable device 20 generates the sensing information according to the movement of the user who is running and transmits the sensing information to the server 30. The server 30 estimates the grounding state and the muscle elastic characteristics of the user on the basis of the received sensing information. Moreover, the server 30 determines the state of the running form of the user on the basis of the estimated grounding state and muscle elastic characteristics and transmits control information according to the determination to the wearable device 20.

Moreover, the wearable device 20 feeds back the determination to the user in various formats according to the type of the device which functions as the presentation unit 230 of the wearable device 20. More specifically, in a case where the wearable device 20 incorporates an earphone, the wearable device 20 outputs sounds different according to the determination regarding the running form. In other words, the wearable device 20 outputs first voice in a case where it is determined that the running form is excellent (for example, in a case where evaluation point is equal to or higher than 60 points) and outputs second voice different from the first voice in a case where it is determined that the running form is not excellent (for example, in a case where evaluation point is less than 60 points). Alternatively, only in a case where it is determined that the running form is excellent, the wearable device 20 may output predetermined sound according to running steps of the user. For example, for each step, the predetermined sound is output or is not output according to the determination regarding each step. Furthermore, in a case where the wearable device 20 includes a light emitting element such as a lamp, the wearable device 20 may feed back the determination regarding the running form to the user by emitting light in a predetermined pattern or light of a predetermined color. Alternatively, in a case where the wearable device 20 includes a vibration device, the wearable device 20 may feed back the determination regarding the running form to the user by vibrating in a predetermined pattern.

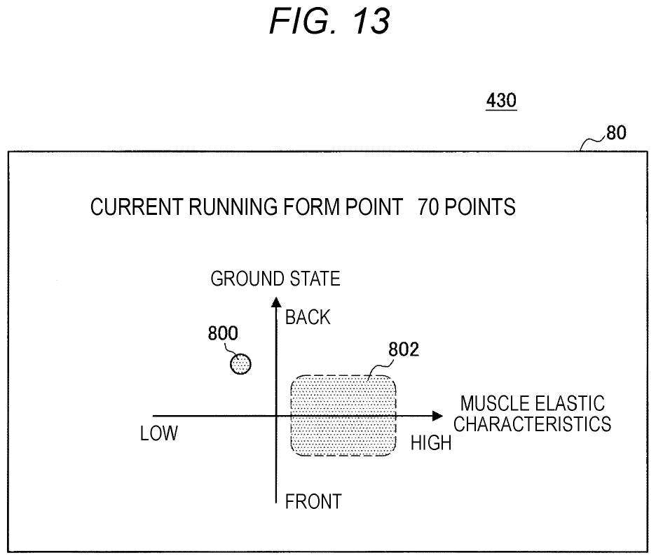

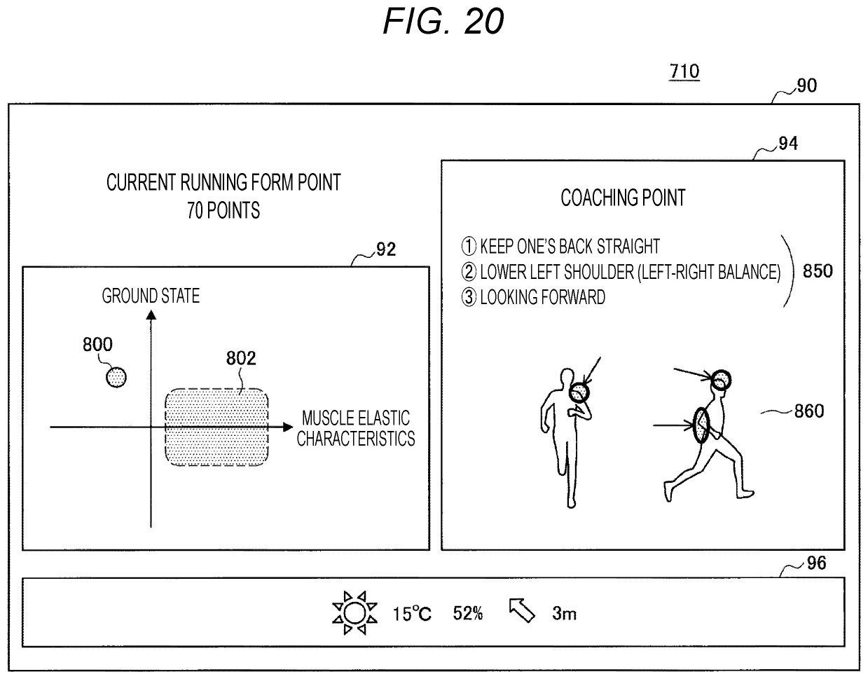

Furthermore, in a case where the wearable device 20 is a device having an eyewear type display 102, an image indicating the determination regarding the running form may be displayed. For example, as illustrated in FIG. 13 which is an explanatory diagram for explaining an example of a display screen according to a modification of the first example, a screen 80 is displayed on the display which is the presentation unit 230 of the wearable device 20. On the upper side of the screen 80, the evaluation point of the running form (for example, FIG. 13, 70 points is displayed as evaluation point) is illustrated as the determination result of the running form of the user. The evaluation point is an evaluation point relative to the running form of the user in a case where a score of the excellent state of the running form is full points of 100 points. Moreover, on the lower side of the screen 80, as in FIG. 10 described above, the XY coordinate axes regarding the grounding state and the muscle elastic characteristics are illustrated. On the XY coordinate axes, the grounding state and the muscle elastic characteristics estimated by the estimation unit 330 are illustrated as the marker 800. In other words, the coordinates of the marker 800 indicate the grounding state and the muscle elastic characteristics of the user in real time. Moreover, as in FIG. 10, on the XY coordinate axes, the region 802 indicating the range of the preferable running form is illustrated. Therefore, by visually recognizing the screen 80, the user can grasp a relation between the current running form of the user and the excellent running form and uses the relation to improve the running form of the user. Moreover, in a case where the wearable device 20 is a device having the eyewear type display 102, a human-like icon 860 (refer to FIG. 20) having a figure of a running person may be displayed. The human-like icon 860 indicates the state of the user who is running, and more specifically, for example, has a figure of a person who is running in a forwardly inclined posture in a case where the body of the user is inclined forward. By visually recognizing such a human-like icon 860, the user or the third party can intuitively grasp the state of the running form and can use the grasped information to improve the running form of the user or the third party.

As described above, according to the first example, the state of the running form of the user can be fed back to the user who is running in real time therefore, not only athletes but also ordinary people who enjoy jogging and the like can grasp the state of their own running forms in real time and can use the grasped running form to improve the their own running forms. Furthermore, since the user can grasp the state of the running form by oneself, the third party who confirms the running form of the user and the like is not needed, and the user can easily use the information processing system 1 according to the present embodiment. Moreover, in the first example, the information regarding the state of the running form is presented to the user in a form which can be intuitively understood such as the evaluation point, the display on the XY coordinate axes, and the like, even children can easily understand the state of their own running form.

<3.2. Second Example>

Next, a second example will be described which provides the state of the running form of the user to the third party other than the user, for example, a coach or the like, who instructs the user, in real time. Note that, here, the third party is not limited to specialists who have knowledge about sports such as professional running and includes ordinary people who transmit the state of the running form of the user to the user and give simple advice. Furthermore, in the present example, it is assumed that the third party use the user terminal 70 having the display. In such a case, even when a large amount of information is displayed on the display, the user can visually recognize the information. Therefore, unlike the first example, other information regarding the state of the running form or the like can be further displayed, and for example, a history of a change in the running form and the like can be displayed.

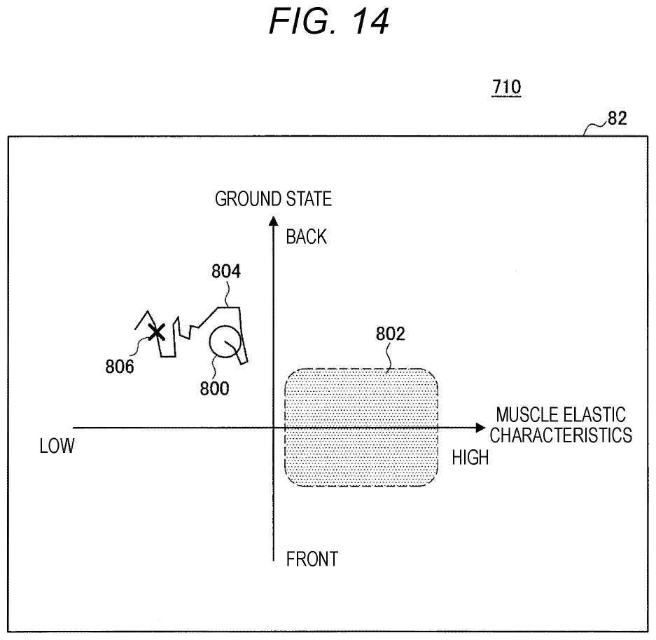

Specific contents of the second example will be described. with reference to FIG. 14. FIG. 14 is an explanatory diagram for explaining an example of a display screen according to the second example. On a display which is the output unit 710 of the user terminal 70, a screen 82 illustrated in FIG. 14 is displayed. In the screen 82, as in FIG. 10, XY coordinate axes regarding the grounding state and the muscle elastic characteristics are illustrated. On the XY coordinate axes, the grounding state and the muscle elastic characteristics estimated by the estimation unit 330 are indicated by the marker 800 and a curved line 804. Specifically, the circular marker 800 indicates an index regarding the latest state of the running form, and the curved line 804 indicates a change in the index regarding the state of the running form in the past. Therefore, according to the screen 82, the third party can intuitively grasp the change in the state of the running form of the user according to the coordinates and the shape of the locus of the curved line 804. For example, in a case where the running form is broken (running form is broken due to tiredness or the like) by long-distance running by the user, the third party can intuitively grasp that the running form is broken by the curved line 804 indicated in the screen 82.

Moreover, in the present example, when the third party performs an input operation to the user terminal 70 when making an instruction to the user, an index at the timing of the instruction can be indicated. More specifically, in the screen 82, the index at the timing of the instruction is indicated by an X-shaped marker 806. In this way, according to the present example, since the index at the timing of the instruction is also indicated. Therefore, the user can intuitively grasp the change in the state of the running form from the time when the third party has made the instruction to the user and easily verify an effect of the instruction.

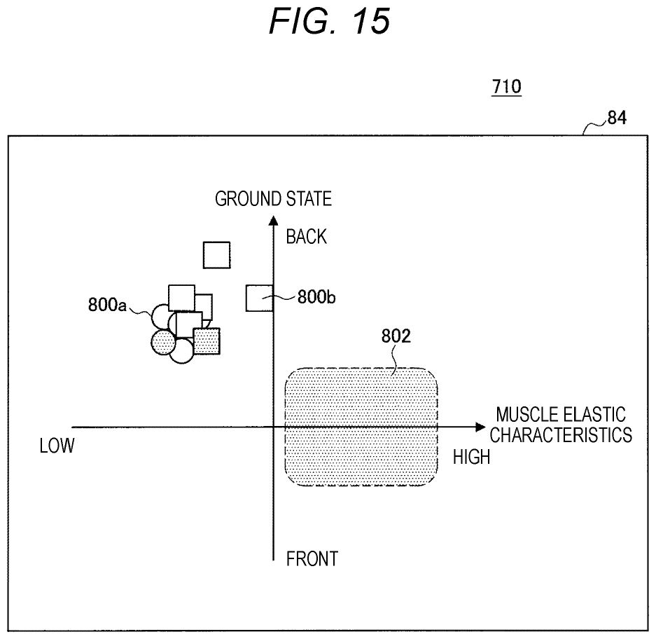

Moreover, a modification according to the second example will be described with reference to FIG. 15. FIG. 15 is an explanatory diagram for explaining an example of a display screen according to the modification of the second example and illustrates a screen 84 displayed on the output unit 710. As in FIG. 14, in the screen 84, the XY coordinate axes regarding the grounding state and the muscle elastic characteristics are illustrated, and two types of markers 800a and 800b respectively corresponding to histories of the grounding state and the muscle elastic characteristics illustrated on the XY coordinate axes are illustrated. Specifically, the circular marker 800a indicates an index regarding a state of a right-foot running form for each step, and the rectangular marker 800b indicates an index regarding a Left-foot running form for each step. Furthermore, in the screen 84, the markers 800a and 800b indicating the indexes regarding the history in the past are illustrated as outlined markers, and the markers 800a and 800b indicating the latest indexes are filled.

In this way, in the present example, by separately displaying the right foot and the left foot, the third party can intuitively grasp the tendency of the state of each foot of the user. More specifically, in the screen 84, although the markers 800a indicating the index of the right, foot are concentrated in a certain range, the markers 800b indicating the index of the left foot are illustrated in a range wider than that of the marker 800a. From this, the third party can. intuitively grasp that the state of the left foot of the user who is running is unstable. In other words, according to the present example, by separately indicating the history information of each index and the index for each of the right foot and the left foot, the third party can intuitively grasp the tendency of the state of the running form of the user. Therefore, the third party can accurately grasp the tendency of the state of the running form of the user and appropriately instruct the user on the basis of the grasped information.

Note that the determination unit 332 may make a determination regarding the state of the running form of the user by executing statistical processing on the plurality of estimated indexes. For example, the determination unit 332 may determine the state of the running form by comparing a distribution range of the indexes acquired by the statistical processing with a predetermined value. The value acquired by the statistical processing can be used as a reference point at the time when the state of the running form and the like is analyzed and can be also used as an objective index for enhancing understanding by the user and the coach. Furthermore, although the two indexes including the grounding state and the muscle elastic characteristics are displayed on the XY coordinate axes in FIGS. 14 and 15, the present embodiment is not limited to this. For example, the three indexes may be displayed on three coordinate axes of XYZ by additionally displaying an index of the grounding time and the like.

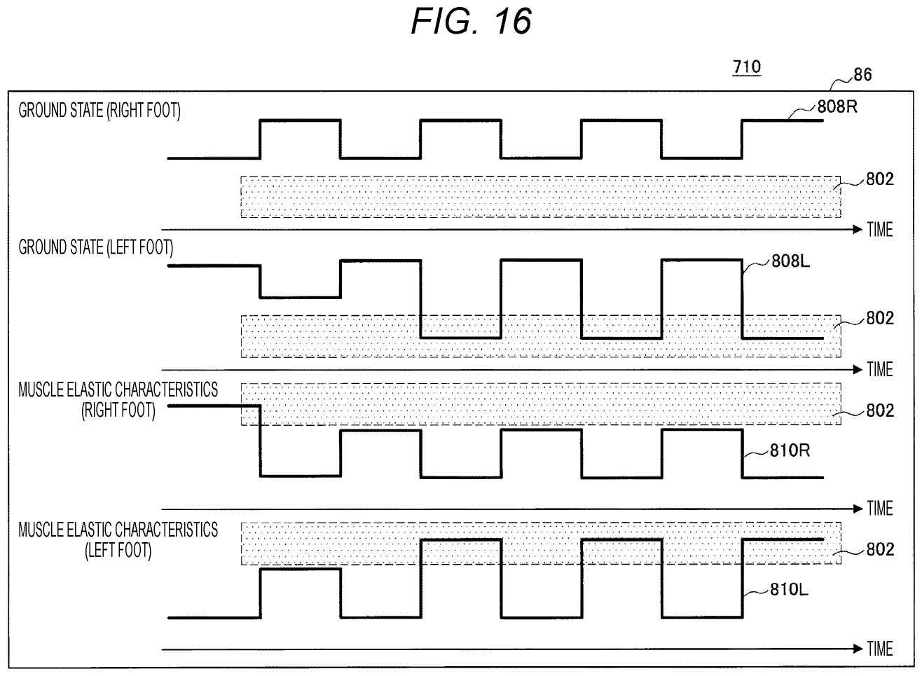

Moreover, another modification of the second example will be described with reference to FIG. 16. FIG. 16 is an explanatory diagram for explaining an example of a display screen according to the modification of the second example and illustrates a screen 86 displayed on the output unit 710. The screen 86 displays temporal changes in the estimated grounding state and muscle elastic characteristics of the user with respect to a running time. Specifically, in the uppermost row of the screen 86, a temporal change 808R in the grounding state of the right foot is illustrated, and in the second row from the top, a temporal change 8081 in the grounding state of the left foot is illustrated. Each of the temporal changes 808L and 808R in the grounding state of each foot is illustrated in a rectangular wave in accordance with each step, and a portion projecting downward indicates a state where the sole of the foot is grounded. The vertical axis of each of the temporal changes 808R and 808L of the grounding state indicates an amount in which the position of the portion in the sole grounded first in each step is separated from the center of the sole, and as each of the temporal changes 808R and 808L moves downward, the position of the portion in the sole grounded first moves closer to the center of the sole. Therefore, regarding the temporal changes 808L and 808R, as the amount of the portion projected downward is larger, the position of the portion in the sole grounded first, moves closer to the center of the sole in each step, the grounding state approaches the excellent grounding state. Moreover, in the screen 86, the region 802 which is the preferable grounding state is displayed together with the temporal changes 808L and 808R. Therefore, if the portions of the temporal changes 808L and 808R projected downward are included in the region 802, the third party can intuitively grasp that the grounding state is preferable.

Furthermore, in the screen 86, in the second row from the top, a temporal change 810R in the muscle elastic characteristics of the right foot is illustrated, and in the second row from the top, a temporal change 810L in the muscle elastic characteristics of the left foot is illustrated. Each of the temporal changes 8101 and 810R in the muscle elastic characteristics of each foot is illustrated in a rectangular wave in accordance with each step, and the portion projected upward indicates a state where the sole of the foot is grounded. The vertical axis of the temporal changes 810R and 810L in the muscle elastic characteristics indicates a magnitude of the muscle elastic characteristics in each step, and the magnitude of the muscle elastic characteristics in each step increases as the temporal change moves upward. Therefore, regarding the temporal changes 810L and 810R, as the amount of the portion projected upward increases, the magnitude of the muscle elastic characteristics increases and approaches the excellent muscle elastic characteristics. Moreover, in the screen 86, the region 802 which is the preferable grounding state is displayed together with the temporal changes 810L and 810R. Therefore, if the portions of the temporal changes 810L and 810R projected upward are included in the region 802, the third party can intuitively grasp that the grounding state is preferable.

Note that, in the above description, it has been described that the state of the running form of the user is presented to the third party in real time. However, the present example is not limited to this, and the state of the running form may be presented to a user after running. In this case, the user can easily grasp the history regarding the running of the user, the user can examine the content of the running of the user and uses the examined content to improve the running form of the user.

<3.3. Third Example>

In the second example described above, the history information of the index in single-time running is presented to the user or the third party. However, the present embodiment is not limited to this. For example, in the present embodiment, history information of an index regarding a state of a running form of the user for several days or several months, not the history in the single-time continuous running, may be presented to the user or the third party. In this way, by presenting the change in the index regarding the running form over a long time, the user or the third party can verify an effect of training for a long time and can use the verification to further improve the running form. Such an example will be described below.

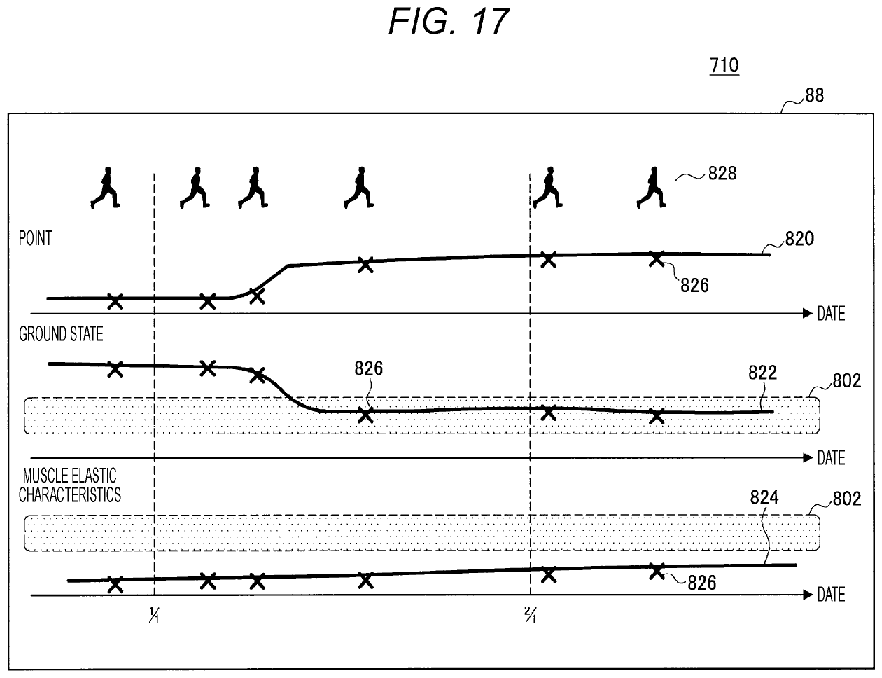

Specific contents of the third example will be described. with reference to FIG. 17. FIG. 17 is an explanatory diagram for explaining an example of a display screen according to the third example of the present embodiment and illustrates a screen 88 displayed on the output unit 710. The screen 88 illustrates, for example, temporal changes in the estimated grounding state and muscle elastic characteristics of the user and a temporal change in a point as determination regarding the running state for a training period over several days or several months. Specifically, in the second row in the screen 88, a temporal change 820 in the evaluation point with respect to the running form of the user is illustrated, in the third row from the top, a temporal change 822 in the grounding state is illustrated, and in the lowest row, a temporal change in the muscle elastic characteristics is illustrated. Note that, as the evaluation point, the grounding state, and the muscle elastic characteristics of each day, average values or the like of the evaluation point, the grounding state, the muscle elastic characteristics of the day are used. Furthermore, as the temporal change 820 shifts upward in FIG. 17, this means that the evaluation point has increased. Moreover, as the temporal change 822 shifts downward in FIG. 17, this indicates that the grounding state is improved, and as the temporal change 804 shifts upward in FIG. 17, this indicates that the muscle elastic characteristics are improved. In addition, as in FIG. 16, in the screen 88, the region 802 which indicates the preferable grounding state and muscle elastic characteristics is illustrated together with the temporal changes 822 and 824 in the grounding state and the muscle elastic characteristics. Furthermore, in the screen 88, a day when the third party has instructed the user is indicated by an X-shaped marker 826.

More specifically, according to the screen 88, the evaluation point of the running form of the user at the beginning of the training is low as indicated by the temporal change 820. Moreover, since the temporal changes 822 and 824 in the grounding state and the muscle elastic characteristics are not in the region 802 at the beginning, it can be found that the grounding state and the muscle elastic characteristics have not been excellent. Moreover, according to the screen 88, it is found that the user continues training and instructed by the third party at a plurality of times, and as a result, the evaluation point indicated by the temporal change 820 increases. Furthermore, according to the screen 88, since the temporal change 822 is included in the region 802, it can be found that the grounding state is improved. however, according to the screen 88, unlike the grounding state, the temporal change 824 in the muscle elastic characteristics is not included in the region 802 even when the user has been instructed at the plurality of times. Therefore, it is found that the muscle elastic characteristics are not much improved.

As described above, according to the third example, the temporal changes in the evaluation point and the index of the user over several days or several months can be presented to the user or the third party in a form which can be easily grasped. Since a numerical value acquired by a graph and statistical processing can be intuitively and objectively grasped, the user or the third party can easily use the information presented in the third example for the verification of the effect of the training and the examination regarding how to improve the running form.

Furthermore, in the uppermost row in the screen 88, an image 828 of the user who is running may be illustrated. The image 828 is acquired by the image acquisition unit 360 of the server 30 from an imaging device (not illustrated) which images the figure of the user who is running. Note that the image 828 may be a typical still image indicating a running state of the user on that day, or display of a moving image of the user who is performing training on that day may be started by making an operation on each image 828. In the present example, by displaying the image 828 of the user who is running together with the temporal change, for example, in the evaluation point, the user or the third party can easily verify the method for improving the running form of the user and the like with reference to the image as necessary.

Note that the display screen according to the present example is not limited to the screen 88 illustrated in FIG. 17. In the present example, for example, it is possible to display the numerical value of the evaluation point and display a value of a distance of the running in the training on that day. Moreover, it is possible to display information used to specify a person who has made an instruction. Furthermore, in the present example, content of the instruction, specifically, information such as “instructed the user to incline the trunk of the user at the time of running in a direction closer to the vertical direction”, “instructed the user to consciously look at a five-meter front side of the user who is running” may be displayed. Moreover, in the present example, the instruction content may be information such that the instruction is specifically made regarding the grounding state or the muscle elastic characteristics, for example. Moreover, in the present example, information regarding a user's goal input by the user or the third party may be displayed. As viewing the displayed content of the goal, the user or the third party can confirm whether or not the user has achieved the goal. By displaying such information, the examination regarding the instruction content and training can be deepened. By providing the information regarding the instruction content of the training of the user and the like in this way, information which is particularly useful when the user voluntarily performs training is provided to the user. Therefore, more effective training can be performed by using the presented information. Note that, for example, the information described above is input to the server 30 by performing an input operation to the user terminal 70 by the third party when making the instruction to the user and is provided to the user or the third party by displaying the screen as described above.

<<4. Second Embodiment>>

As described above, it is difficult for ordinary people who do not have technical knowledge to grasp the current running form of the user and provide an appropriate advice to improve the running form according to the grasped running form. Therefore, in the present embodiment, a second embodiment will be described which can provide an appropriate advice to a user or a third party who is not a specialist by using a grounding state and muscle elastic characteristics estimated as in the first embodiment.

<4.1. Configuration of Server 30 According to Second Embodiment>

Note that, in the present embodiment, configurations of an information processing system 1, a wearable device 20, and a user terminal 70 are common to those in the first embodiment, and the description regarding these configurations in the first embodiment may be referred. Therefore, here, the description of the configurations of the information processing system 1, the wearable device 20, and the user terminal 70 is omitted, and a server 30 will be described.

Furthermore, the server 30 according to the present embodiment has a similar configuration to the block diagram of the server 30 according to the first embodiment illustrated in FIG. 7. However, in the present embodiment, an operation of an information selection unit 334 is different from that in the first embodiment. Therefore, here, description regarding functional units common to those in the first embodiment is omitted, and only the information selection unit 334 will be described.

The information selection unit 334 selects an advice to be provided to a user or a third party other than the user from information stored in a storage unit 350 according to an estimation result of an estimation unit 330. Then, the information selection unit 334 outputs the selected advice to the output control unit 326. Note that the operation of the information selection unit 334 will be described below in detail.

<4.2. Information Processing Method According to Second Embodiment>

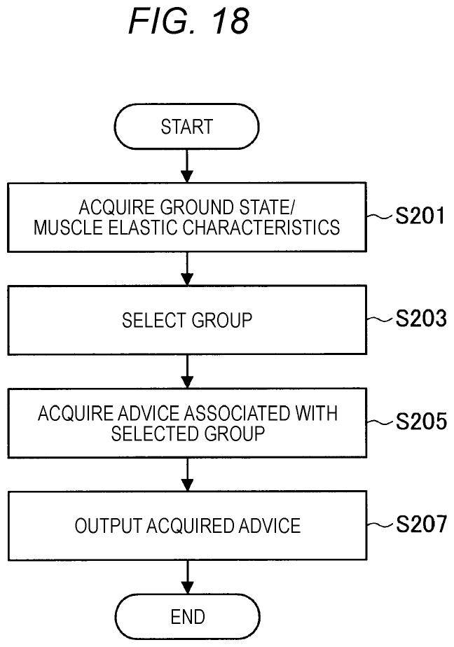

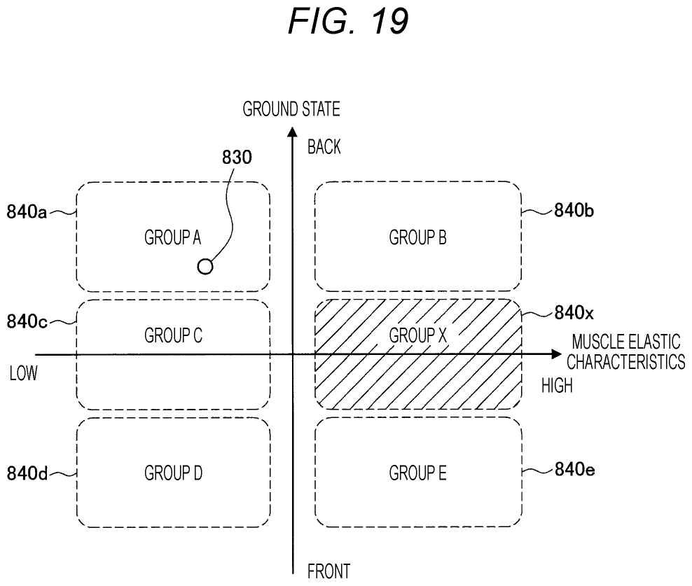

Next, an information processing method according to the second embodiment, in other words, an example of the operation of the information selection unit 334 will be described with reference to FIGS. 18 to 20. FIG. 18 is a flowchart for explaining an example of the information processing method according to the present embodiment. FIG. 19 is an explanatory diagram for explaining an example of the operation of the information selection unit 334 according to the present embodiment. Moreover, FIG. 20 is an explanatory diagram for explaining an example of a display screen according to the present embodiment. As illustrated in FIG. 18, the information processing method according to the present embodiment includes a plurality of steps from step S201 to step S207. Each step included in the information processing method according to the present embodiment will be described in detail below.

(Step S201)

The information selection unit 334 acquires a grounding state and muscle elastic characteristics of the user estimated by the estimation unit 330 in step S103 in the first embodiment in FIG. 12.

(Step S203)

The information selection unit 334 selects a group to which a state of a running form of the user belongs on the basis of the estimation result acquired in step S203 described above.

Hereinafter, a method for selecting the group by the information selection unit 334 will be described with reference to FIG. 19. As in FIG. 10 described above, in FIG. 19, XY coordinate axes regarding the grounding state and the muscle elastic characteristics are illustrated. Moreover, as illustrated in FIG. 19, on the XY coordinate axes, a plurality of regions 840a to 840e and 840x are set. The respective regions 840a to 840e and 840x are set as ranges which can be assumed as groups a to e and x which can be determined as groups in which the states of the running form have a similar tendency on the basis of the grounding state and the muscle elastic characteristics. For example, a grounding state and muscle elastic characteristics of the group x corresponding to the region 840x are within an excellent range, and the group x is a group which is estimated to be the preferable state of the running form. On the other hand, since the group a corresponding to the region 840a of which the grounding state is a state where the heel is grounded first and the muscle elastic characteristics are low, the group a as estimated as a group which is not in the preferable state of the running form. As described above, the grounding state and the muscle elastic characteristics have the correlation with the state of the running form. Therefore, the states of the running form can be distinguished from each other by using the grounding state and the muscle elastic characteristics.

Then, the information selection unit 334 plots two indexes (grounding state and muscle elastic characteristics) estimated by the estimation unit 330 on the XY coordinate axes in FIG. 19 and selects a group corresponding to a region including the plotted marker 830 as a group to which the state of the running form of the user belongs. For example, in the example illustrated in FIG. 19, since the marker 830 is included in the region 840a, the information selection unit 334 selects the group a as the group to which the state of the running form of the user belongs.

(Step S205)

Next, the information selection unit 334 selects an advice to be provided to the user or the third party on the basis of the selection result in step S203 described above.

Specifically, in each group divided according to the grounding state and the muscle elastic characteristics as described above, the states of the running form have a common tendency. Therefore, it is considered that an instruction method for leading a preferable running form has a common tendency. For example, an instruction of “Keep one's back straight” is effective for runners belonging to a group A, and the instruction of “Keep one's back straight” is not effective for runners belonging to a group B. In other words, an instruction for leading an appropriate running form exists for each group according to the tendency of the state of the running form. Therefore, in the present embodiment, the storage unit 350 previously stores a specific instruction method which has been effective for runners belonging to each group in association with each group. Furthermore, the instruction method to be stored may be constructed according to the instruction of the coach who has technical knowledge or may be constructed by information acquired when the information processing system 1 according to the present embodiment is operated in this way, the information selection unit 334 selects the group to which the state of the running form of the user belongs on the basis of the estimation result of the estimation unit 330 and selects the instruction method associated with the selected group from the storage unit 350 as an advice.

(Step S207)

The information selection unit 334 outputs the acquired advice to an output control unit 326.

More specifically, the instruction method selected in step S207 is presented by a screen 90 illustrated in FIG. 20 to the user or the third party. FIG. 20 is an explanatory diagram for explaining an example of a display screen according to the present embodiment and illustrates the screen 90 displayed on an output unit 710. As in FIG. 13 described above, on the screen 90, an evaluation point of the running form of the user is illustrated on the upper left side of the screen 90, and in a window 92 on the lower left side, as in FIG. 10 described above, the grounding state and the muscle elastic characteristics are illustrated as the marker 800 on the XY coordinate axes.

Moreover, as illustrated in FIG. 20, in a window 94 on the upper right side in FIG. 20, the advice selected in step S205 is illustrated as an instruction point 850. Specifically, in FIG. 20, as the instruction point 850, three advices such as “Keep one's back straight”, “Lower the left shoulder (left-right balance)”, and “Looking forward” are illustrated. The user can perform training on the basis of the displayed instruction points 850, and the third party can provide an appropriate advice to the user by selecting the point from among the displayed instruction points 850 which is determined to be necessary and transmitting the selected point to the user.

In addition, in the window 94, a human-like icon 860 having a figure of a person who is running is illustrated. As described above, the human-like icon 860 has a shape indicating a state of the user who is running. Moreover, by displaying an arrow and the like pointing the part of the human-like icon 860, a portion of the body which should be cared when the user is running is clearly indicated. By using such a human-like icon 860, the user or the third party can intuitively grasp the state of the running form and the points to be cared. Note that the display of the human-like icon 860 can be realized by selecting an icon corresponding to the advice selected in step S205 by the information selection unit 334.

Moreover, in a window 96 on the lower side in the screen 90 in FIG. 20, weather conditions such as the weather, temperature, wind speed, and wind direction at the time when the user runs are illustrated as icons or numerical values. In this way, in the present embodiment, it is preferable to display comprehensive information such as surrounding environment or the user who is running on the screen. The user or the third party can examine the running form of the user and the like on the basis of such comprehensive information. Note that, for example, the information regarding the weather conditions and the like may be acquired by performing an input operation to the user terminal 70 by the user or the third party or may be acquired by using a temperature sensor, an atmospheric pressure sensor, and the like built in the wearable device 20. Alternatively, the information regarding the weather conditions may be acquired from a database (not illustrated) of a weather forecast company and the like via a network 98.

As described above, in the present embodiment, it is possible to select the group to which the state of the running form of the user belongs by using the grounding state and the muscle elastic characteristics estimated as in the first embodiment and present the advice according to the selected group to the user and the like. Therefore, according to the present embodiment, a person who is not a specialist can acquire an appropriate advice according to the state of the running form of the user. Note that the information regarding the instruction method provided in the present embodiment may be constructed by accumulating information of an instruction method, which is determined to be highly effective by using the first embodiment, in the server 30. Furthermore, the information regarding the advice may be constructed by using statistical information indicating a correlation between the change in the index acquired in the first embodiment and each instruction method. The information constructed in this way can be used not only to improve the running form of the user but also to improve coaching skills of the coach.

Note that, in the present embodiment, the method for selecting the instruction method by the information selection unit 334 is not limited to the above method, and other method may be used.

<<5. Summary>>

As described above, according to the embodiment of the present disclosure, a system can be provided which can feed back the state of the running form to the user in real time and can be easily used. As a result, since the user or the third party can grasp the state of the running form of the user in real time, the running form of the user can be effectively examined, for example.

In the above description, an example has been described in which the embodiment of the present disclosure is applied to long-distance running such as jogging and running as an example of running and walking. However, the embodiment of the present disclosure is not limited to the application to the long-distance running. For example, the present embodiment may be applied to a short-distance running such as a track as one of running and walking or may be applied to walk-ng such as tracking for walking in mountains and the like for a long distance. Moreover, the present embodiment may be applied to other sports such as speed skating, and cross country skiing. In this case, an index used to grasp the running and walking states and the like is changed according to the content of the running and walking to which the present. embodiment is applied, the kind of sports, and the like, and in addition, the quality of running and walking state and the like can be differently determined.

Furthermore, in the embodiments described above, by making the wearable device 20 according to the present embodiment function as the server 30, the wearable device 20 may be used as a stand-alone device. In such a case, the function of the learning device 600 is performed by the other information processing apparatus, and the DB 610 storing the relation information indicating a relation between the sensing information, the grounding state, and the like by machine learning by the other information processing apparatus is stored in the wearable device 20. In this way, processing functions of the wearable device 20 can be reduced, and the wearable device 20 can have a compact shape. Therefore, even when the wearable device 20 is a stand-alone device, the wearable device 20 can be worn on various portions of the body of the user.

<<6. Regarding Hardware Configuration>>

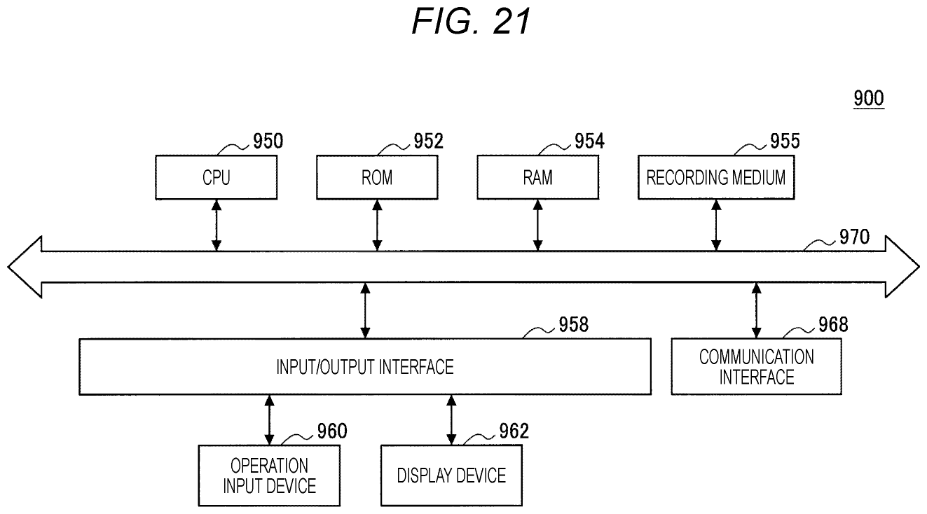

FIG. 21 is an explanatory diagram illustrating an exemplary hardware configuration of an information processing apparatus 900 according to the present embodiment. In FIG. 21, the information processing apparatus 900 indicates an exemplary hardware configuration of the server 30 described above.

The information processing apparatus 900 includes, for example, a CPU 950, a ROM 952, a RAM 954, a recording medium 956, an input/output interface 958, and an operation input device 960. Moreover, the information processing apparatus 900 includes a display device 962, a communication interface 968, and a sensor 980. Furthermore, the information processing apparatus 900 connects between components, for example, by a bus 970 as a data transmission path.

(CPU 950)

The CPU 950 includes, for example, one or two or more processors configured by an arithmetic circuit such as a CPU, various processing circuits, and the like and functions as a control unit (not illustrated) which controls the entire information processing apparatus 900 and a processing unit 324 which estimates the grounding state of the user and determines the running state of the user, for example.

(ROM 952 and RAM 954)

The ROM 952 stores control data such as a program and a calculation parameter used by the CPU 950 and the like. The RAM 954 temporarily stores, for example, a program to be executed by the CPU 950 or the like. The ROM 952 and the RAM 954 function, for example, as the storage unit 350 described above, in the information. processing apparatus 900.

(Recording Medium 956)

The recording medium 956 functions as the storage unit 350 described above and stores various data, for example, data regarding the information processing method according to the present embodiment, various applications, and the like. Here, as the recording medium 956, for example, a magnetic recording medium such as a hard disk and a nonvolatile memory and such as a flash memory are exemplified. Furthermore, the recording medium 956 may be detachable from the information processing apparatus 900.

(Input/Output Interface 958, Operation Input Device 960, and Display Device 962)

The input/output interface 958 connects, for example, the operation input device 960, the display device 962, and the like to each other. As the input/output interface 958, for example, a Universal Serial Bus (USB) terminal, a Digital Visual Interface (DVI) terminal, a High-Definition Multimedia Interface (registered trademark) terminal, various processing circuits, and the like can be exemplified.

The operation input device 960 functions as the input unit 300 and, for example, is included in the information processing apparatus 900. In the information processing apparatus 900, the operation input device 960 is connected to the input/output interface 958. As the operation input device 960, for example, a button, a direction key, a rotary selector such as a jog dial, a touch panel, a combination of these, or the like can be exemplified.

The display device 962 functions as the output unit 310 and, for example, is included in the information processing apparatus 900. In the information processing apparatus 900, the display device 962 is connected to the input/output interface 958. As the display device 962, for example, a liquid crystal display, an Organic Electro-Luminescence (EL) Display, and the like can be exemplified.

Note that it goes out without saying that the input/output interface 958 can be connected to an external device such as an operation input device outside the information processing apparatus 900 (for example, keyboard, mouse, and the like) and an external display device.

(Communication Interface 968)

The communication interface 968 is a communication unit included in the information processing apparatus 900 which functions as the communication unit 340 and functions as a communication unit (not illustrated) which wiredly or wirelessly communicates with an external device such as a server via a network (or directly). Here, as the communication interface 968, for example, a communication antenna and a Radio Frequency (RF) circuit (wireless communication), an IEEE802.15.1 port and a transmission and reception circuit (wireless communication), an IEEE802.11 port and a transmission and reception circuit (wireless communication), a Local Area Network (LAN) terminal and a transmission and reception circuit (wired communication), or the like can be exemplified.

The exemplary hardware configuration of the information processing apparatus 900 has been described above. Note that the hardware configuration of the information processing apparatus 900 is not limited to the configuration illustrated in FIG. 21. Specifically, each component described above may be formed by using a general-purpose member and may be formed by hardware specialized for the function of each component. The configuration may be appropriately changed according to a technical level at the time of implementation.

For example, in a case where the information processing apparatus 900 communicates with the external device via a connected external communication device and the like and in a case where the information processing apparatus 900 has a configuration for executing processing in a stand-alone manner, the information processing apparatus 900 does not need to include the communication interface 968. Furthermore, the communication interface 968 may have a configuration which can communicate with one or two or more external devices by a plurality of communication methods. Furthermore, for example, the information processing apparatus 900 can have a configuration which does not include the recording medium 956, the operation input device 960, the display device 962, and the like.

Furthermore, the information processing apparatus according to the present embodiment may be applied to a system including a plurality of devices on the premise of connection to a network (or communication between devices), for example, cloud computing or the like. That is, the information processing apparatus according to the present embodiment can be realized as, for example, an information processing system which executes processing according to the information processing method of the present embodiment by the plurality of devices.

<<7. Supplement>>

Note that the embodiments of the present disclosure described above may include, for example, a program which causes a computer to function as the information processing apparatus according to the present embodiment and a non-temporary tangible medium in which the program is temporary recorded. Furthermore, the program may be distributed via a communication line (including wireless communication) such as the Internet.

Furthermore, it is not necessary to necessarily process each step in the processing in each embodiment described above in the described order. For example, each step may be processed in an appropriately changed order. Furthermore, each step may be partially processed in parallel or individually processed instead of being processed in time series manner. Moreover, the processing method of each step does not need to be necessarily processed along the described method, and, for example, may be processed by other method by other functional unit.

The preferred embodiments of the present disclosure have been described in detail above with reference to the drawings. However, the technical scope of the present disclosure is not limited to the embodiments. It is obvious that a person who has normal knowledge in the technical field of the present disclosure can arrive at various variations and modifications in the scope of the technical ideas described in claims. It is understood that the variations and modifications naturally belong to the technical scope of the present disclosure.

Furthermore, the effects described in the present description are merely illustrative and exemplary and not limited. That is, the technology according to the present disclosure can exhibit other effects obvious to those skilled in the art from the description in the present specification together with or instead of the above described effects.

Note that the following configuration belongs to the technical scope of the present disclosure.

(1) An information processing apparatus including:
a sensing information acquisition unit configured to acquire sensing information from a single or a plurality of sensors worn on a body of a user who is running or walking;
an estimation unit configured to estimate a grounding state of a foot of the user from the sensing information; and
a notification unit configured to notify information regarding a running and walking state of the user on the basis of the estimated grounding state.

(2) The information processing apparatus according to (1), in which
the estimation unit estimates a position of a portion. in a sole which has contact with ground first in each step regarding running and walking of the user as estimation of the grounding state.

(3) The information processing apparatus according to (1) or (2), further including:
a storage unit configured to store relation information indicating a relation between the sensing information and the grounding state, in which
the estimation unit estimates the grounding state by using the relation information stored in the storage unit in advance.

(4) The information processing apparatus according to (3), further including:
a learning device configured to perform machine learning on the relation information.

(5) The information processing apparatus according to (1), in which
the estimation unit estimates muscle elastic characteristics of the foot of the user from the sensing information.

(6) The information processing apparatus according to (5), in which
the estimation unit estimates elastic energy acquired in muscles of the foot of the user in each step regarding running and walking of the user as estimation of the muscle elastic characteristics.

(7) The information processing apparatus according to (5) or (6), further including:
a storage unit configured to store relation information indicating a relation between the sensing information and the muscle elastic characteristics, in which
the estimation unit estimates the muscle elastic characteristics by using the relation information stored in the storage unit in advance.

(8) The information processing apparatus according to any one of (1) to (7), in which
the sensing information includes sensing information acquired from an acceleration sensor or a gyro sensor worn on the user.

(9) The information processing apparatus according to any one of (1) to (8), further including:
a determination unit configured to determine the running and walking state of the user on the basis of the estimated grounding state.

(10) The information processing apparatus according to (9), in which
the determination unit determines the running and walking state of the user on the basis of a grounding time of the sole of the user in each step regarding running and walking of the user acquired from the sensing information.

(11) The information processing apparatus according to (9) or (10), in which
the notification unit notifies a determination result by the determination unit.

(12) The information processing apparatus according to any one of (1) to (11), in which
the notification unit notifies the user who is walking or running of information regarding the running and walking state of the user in real time.

(13) The information processing apparatus according to (12), in which
the notification unit makes a notification by performing at least one of control for making a voice output device worn on the body of the user output voice, control for making a vibration device worn on the body of the user vibrate, and control for making a display device worn on the body of the user display an image.

(14) The information processing apparatus according to any one of (1) to (13), in which
the notification unit notifies another user other than the user of the information regarding the running and walking state of the user in real time.

(15) The information processing apparatus according to (14), in which
the notification unit notifies the another user by performing control for making a terminal of the another user display an image.

(16) The information processing apparatus according to any one of (1) to (15), in which
the notification unit notifies the user of an advice for improving the running and walking state selected on the basis of the estimated grounding state.

(17) The information processing apparatus according to (16), in which
the notification unit selects a group corresponding to the running and walking state on the basis of the estimated grounding state and notifies the advice associated with the selected group.

(18) The information processing apparatus according to any one of (1) to (17), further including:
an imaging information acquisition unit configured to acquire imaging information from an imaging device that images the user who is running or walking, in which
the notification unit notifies the imaging information.

(19) An information processing method including:
acquiring sensing information from a single or a plurality of sensors worn on a body of a user who is running or walking;
estimating a grounding state of a foot of the user from the sensing information; and
notifying information regarding a running and walking state of the user on the basis of the estimated grounding state.

(20) A program for making a computer implement:
a function for acquiring sensing information from a single or a plurality of sensors worn on a body of a user who is running or walking;
a function for estimating a grounding state of a foot of the user from the sensing information; and
a function for notifying information regarding a running and walking state of the user on the basis of the estimated grounding state.

### REFERENCE SIGNS LIST

1 Information processing system

20, 20a, 20b Wearable device

24, 106 Neck band

22L, 22R, 100L, 100R Main body portion

30 Server

70 User terminal

80, 82, 84, 86, 88, 90 Screen

92, 94, 96 Window

98 Network

102 Display

104 Lens

200 Sensor unit

210, 320, 720 Main control unit

212, 322 Data acquisition unit

214, 324 Processing unit

216, 326 Output control unit

220, 340, 730 Communication unit

230 Presentation unit

300, 700 Input unit

310, 710 Output unit

330 Estimation unit

332 Determination unit

334 Information selection unit

350, 740 Storage unit

360 Image acquisition unit

600 Learning device

610 DB

800, 800a, 800b, 806, 826, 830 Marker

802, 840a, 840b, 840c, 840d, 840d, 840e, 840x Region

804 Curved line

808L, 808R, 810L, 810R, 820, 822, 824 Temporal change

828 Image

850 Instruction point

860 Icon

950 CPU

952 ROM

954 RAM

956 Recording medium

958 Input/output interface

960 Operation input device

962 Display device

964 Voice output device

966 Voice input device

968 Communication interface

970 Bus

1. An information processing apparatus comprising:
a sensing information acquisition unit configured to acquire sensing information from a single or a plurality of sensors worn on a body of a user who is running or walking;
an estimation unit configured to estimate a grounding state of a foot of the user from the sensing information; and
a notification unit configured to notify information regarding a running and walking state of the user on a basis of the estimated grounding state.

2. The information processing apparatus according to claim 1, wherein
the estimation unit estimates a position of a portion in a sole which has contact with ground first in each step regarding running and walking of the user as estimation of the grounding state.

3. The information processing apparatus according to claim 1, further comprising:
a storage unit configured to store relation information indicating a relation between the sensing information and the grounding state, wherein
the estimation unit estimates the grounding state by using the relation information stored in the storage unit in advance.

4. The information processing apparatus according to claim 3, further comprising:
a learning device configured to perform machine learning on the relation information.

5. The information processing apparatus according to claim 1, wherein
the estimation unit estimates muscle elastic characteristics of the foot of the user from the sensing information.

6. The information processing apparatus according to claim 5, wherein
the estimation unit estimates elastic energy acquired in muscles of the foot of the user in each step regarding running and walking of the user as estimation of the muscle elastic characteristics.

7. The information processing apparatus according to claim 5, further comprising:
a storage unit configured to store relation information indicating a relation between the sensing information and the muscle elastic characteristics, wherein
the estimation unit estimates the muscle elastic characteristics by using the relation information stored in the storage unit in advance.

8. The information processing apparatus according to claim 1, wherein
the sensing information includes sensing information acquired from an acceleration sensor or a gyro sensor worn on the user.

9. The information processing apparatus according to claim 1, further comprising:
a determination unit configured to determine the running and walking state of the user on a basis of the estimated grounding state.

10. The information processing apparatus according to claim 9, wherein
the determination unit determines the running and walking state of the user on a basis of a grounding time of the sole of the user in each step regarding running and walking of the user acquired from the sensing information.

11. The information processing apparatus according to claim 9, wherein
the notification unit notifies a determination. result by the determination unit.

12. The information processing apparatus according to claim 1, wherein
the notification unit notifies the user who is walking or running of information regarding the running and walking state of the user in real time.

13. The information processing apparatus according to claim 12, wherein
the notification unit makes a notification by performing at least one of control for making a voice output device worn on the body of the user output voice, control for making a vibration device worn on the body of the user vibrate, and control for making a display device worn on the body of the user display an image.

14. The information processing apparatus according to claim 1, wherein
the notification unit notifies another user other than the user of the information regarding the running and walking state of the user in real time.

15. The information processing apparatus according to claim 14, wherein
the notification unit notifies the another user by performing control for making a terminal of the another user display an image.

16. The information processing apparatus according to claim 1, wherein
the notification unit notifies the user of an advice for improving the running and walking state selected on a basis of the estimated grounding state.

17. The information processing apparatus according to claim 16, wherein
the notification unit selects a group corresponding to the running and walking state on a basis of the estimated grounding state and notifies the advice associated with the selected group.

18. The information processing apparatus according to claim 1, further comprising:
an imaging information acquisition unit configured to acquire imaging information from an imaging device that images the user who is running or walking, wherein
the notification unit notifies the imaging information.

19. An information processing method comprising:
acquiring sensing information from a single or a plurality of sensors worn on a body of a user who is running or walking;
estimating a grounding state of a foot of the user from the sensing information; and
notifying information regarding a running and walking state of the user on a basis of the estimated grounding state.

20. A program for making a computer implement:
a function for acquiring sensing information from a single or a plurality of sensors worn on a body of a user who is running or walking;
a function for estimating a grounding state of a foot of the user from the sensing information; and
a function for notifying information regarding a running and walking state of the user on a basis of the estimated grounding state.
